(19) United States
(12) Patent Application Publication
(10) Pub. No.: US 2026/0311477 A1
(43) Pub. Date: Oct. 8, 2026

(54) NEURAL NETWORK TRAINING PROTOCOL FOR AUTOMATED IMAGE ANALYSIS FOR CLASSIFYING FOREGROUND AND BACKGROUND REGIONS

(71) Applicant: Techcyte, Inc., Orem, UT (US)

(72) Inventors: Richard Boyd Smith, Manati, PR (US); Bryan J. Worthen, South Jordan, UT (US); Shane Swenson, Cottonwood Heights, UT (US); Jared Carlson, Lehi, UT (US)

(73) Assignee: Techcyte, Inc., Orem, UT (US)

(21) Appl. No.: 19/575,758

(22) Filed: Mar. 23, 2026

Related U.S. Application Data
(63) Continuation-in-part of application No. 18/172,191, filed on Feb. 21, 2023, now Pat. No. 12,586,198.
(60) Provisional application No. 63/311,866, filed on Feb. 18, 2022.

(51) Int. Cl. G06V 10/82; G06V 10/26; G06V 10/764; G06V 10/774; G06V 20/69

(52) U.S. Cl. CPC G06V 10/82; G06V 10/26; G06V 10/764; G06V 10/774; G06V 20/695; G06V 20/698

(57) ABSTRACT

Labeling protocols for training datasets and systems and methods for classifying objects of interest and identifying backgrounds. A method includes partitioning an input image into a plurality of grid units and processing the plurality of grid units with an artificial intelligence and/or machine learning (AI/ML) engine to output a classified image, wherein the classified image comprises: one or more background grid units assigned a background classification, and one or more foreground grid units assigned a foreground classification. The method includes calculating an explicit loss function based upon the classified image and a target classification image, wherein the target classification image comprises a background boundary and a foreground boundary. The method includes applying the explicit loss function to the AI/ML engine.

### TECHNICAL FIELD

The present disclosure relates to systems and methods for image analysis and particularly relates to identifying objects and labeling image regions.

### BACKGROUND

Computer-based image analysis uses algorithms and techniques to extract information from digital images. The use of digital image analysis has grown rapidly in recent years, as advances in computer technology and imaging hardware have made it increasingly feasible to capture and store significant quantities of digital image data. Applications of image analysis are diverse, including medical imaging, data analysis, surveillance imaging, robotics, automated vehicle sensing, quality control in manufacturing, and so forth.

In medicine, image analysis can be used to examine microscopy slide images, endoscopy images, X-ray images, and other medical imaging mediums. Automated image analysis can be implemented to identify viruses or bacteria, identify irregularities in cellular function, diagnose diseases, track the progression of diseases, monitor the effectiveness of treatments, and so forth. However, implementing computer-based image analysis of certain medical images, such as microscopy slide images, raises various technical challenges due to the quality of some medical imaging.

Automatic image analysis of microscopy slides poses several challenges due to the complexity of the images and the variability in image quality. Some of the key challenges include variability in sample preparation, i.e., the quality of microscopy slide image is largely dependent on sample preparation, and variations in the thickness of the sample, the staining protocol, and other factors can result in differences in image contrast, brightness, and other parameters that affect image analysis. Additionally, microscopy slide images may include significant noise and image artifacts that interfere with image analysis. For example, the slide images may include speckle noise caused by interference patterns, distortions caused by dust, and scratches or other imperfections on the slide or microscope lens. Additionally, microscopy slide images exhibit variability in object size and shape, and this can make it difficult to identify and segment objects automatically. Further, microscopy slide images are computationally complex due to the complexity of the images, the number of image classifiers within the training dataset, and the difficulties in identifies objects of interest.

In view of the foregoing, disclosed herein are improved systems, methods, and devices for image analysis that may specifically be applied to complex images such as those retrieved from microscopy slide imaging. The systems, methods, and devices described herein implement deep learning algorithms to identify and classify objects of interest in an efficient and accurate manner.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. It will be appreciated by those of ordinary skill in the art that the various drawings are for illustrative purposes only. The nature of the present disclosure, as well as other embodiments in accordance with this disclosure, may be more clearly understood by reference to the following detailed description, to the appended claims, and to the several drawings.

FIG. 1 is a schematic block diagram of a system and process flow for automated image analysis of images retrieved from one or more data sources, wherein the automated image analysis is executed by an artificial intelligence and/or machine learning (AI/ML) engine;

FIG. 2 is a schematic block diagram of a system and process flow for training and optimizing an AI/ML engine to perform automated image analysis to identify background and foreground regions in an input image;

FIG. 3 is a schematic illustration of dataset training layers utilized to train and optimize the AI/ML engine;

FIG. 4A is a schematic illustration of an input image that is partitioned into a plurality of grid units;

FIG. 4B is a schematic illustration of a grid overlay image comprising a plurality of grid units;

FIG. 5 is a schematic illustration of an input image comprising a plurality of objects of interest, wherein each of the plurality of objects of interest is identified with a boundary;

FIG. 6 is a schematic illustration of an input image comprising a plurality of objects of interest each surrounded by a boundary, and wherein the input image is partitioned into a plurality of grid units;

FIG. 7 is a schematic illustration of a plurality of grid units that each comprise a portion of a boundary associated with an object of interest;

FIG. 8 is a schematic illustration of an object of interest surrounded by a boundary, wherein a center point of the boundary is identified;

FIG. 9 is a schematic illustration of a grid unit that comprises the center point of a boundary that is associated with an object of interest;

FIG. 10A is a schematic illustration of an input image comprising background regions and foreground regions;

FIG. 10B is a schematic illustration of the input image illustrated in FIG. 10A, and further includes boundaries for explicitly identifying portions of background regions and foreground regions;

FIG. 11A is an input image comprising focal variation such that the input image includes background regions and foreground regions that are ambiguously separated by a region with moderate focus;

FIG. 11B is the input image illustrated in FIG. 11A, and further includes boundaries for explicitly identifying portions of background regions and foreground regions;

FIG. 12 is a schematic illustration of learned offsets implemented by the AI/ML engine;

FIG. 13 is a schematic illustration of a convolutional neural network that may serve as a component of the AI/ML engine;

FIG. 14 illustrates an example implementation of a model for identifying and classifying objects of interest;

FIG. 15 illustrates an example implementation of a model for identifying and classifying objects of interest;

FIG. 16 illustrates an example implementation of a model for identifying and classifying objects of interest;

FIG. 17 illustrates an example implementation of a model for identifying and classifying objects of interest;

FIG. 18 is a schematic block diagram illustrating operation of a classification system;

FIG. 19 is a schematic illustration of a training model for training a neural network to train a boundary around an object of interest;

FIG. 20 is a schematic flow chart diagram of a method for automated image analysis for partitioning pixel data into background classifications and foreground classifications;

FIG. 21 is a schematic flow chart diagram of a method for automated image analysis for portioning pixel data into background classifications and foreground classifications; and

FIG. 22 illustrates a block diagram of an example computing device in accordance with the teachings and principles of the disclosure.

### DETAILED DESCRIPTION

Disclosed herein are systems, methods, and devices for image analysis for identifying objects and classifying background exclusions. The systems, methods, and devices described herein significantly increase the speed and accuracy of machine learning processes for classifying objects within an image. The processes described herein may specifically be implemented when classifying particles, biological material, viruses, and so forth.

Specifically described herein are training methods and labeling protocols for training a neural network to classify objects of interest within an input image. The labeling protocol described herein includes numerous labeling classifications for drawn boundaries, including explicit background classification, explicit foreground classification, unclassified regions, and exclude classifications. A loss function on the neural network trains the neural network to make object of interest predictions within boundaries comprising the foreground classification, while ignoring data within boundaries comprising the background classification or exclude classification. The explicit labeling protocols described herein enable granular fine-tuning of the neural network to identify only certain objects of interest within an input image.

Microscopy slide images are particularly challenging to classify with machine learning algorithms. Slide images may include a relatively small quantity of rare cells that need to be labeled. These rare cells may be surrounded by hundreds or thousands of non-rare cells that also need to be labeled which creates a significant labeling burden for traditional object detection algorithms. Additionally, slide images typically contain objects that are occluded, blurry, difficult to discern, can be very dense, and are often mislabeled by algorithms and humans. When these objects are included in a training scene, they must be labeled as either a foreground or background class which is problematic when these features create ambiguity about what the object really is. This makes it challenging to create a reliable training data set for training a machine learning algorithm because it will either contain bad labels or ambiguous labels must be excluded. When ambiguous labels are abundant, a sizable portion of the already rare objects become even more difficult to add to training without introducing mislabeled objects. Explicitly labeling background areas, rather than implicitly assuming everything that it not labeled as foreground is background, creates much greater control around what parts of the scene are learned and what is excluded from training. Disclosed herein are improved classification processes that resolve these issues and increase the likelihood that a machine learning algorithm quickly and accurately classifies particles and other materials within a slide image.

The systems and methods for image analysis described herein can be applied to the analysis of laboratory slides that include, for example, microscopy images of bacteria, viruses, particles, cells, and other organisms. The slides and other information may be received from a user, customer, technician, or other entity that has obtained one or more samples. For example, a lab worker may receive the one or more slides and load the slides into a scanner for imaging. The lab worker may scan a barcode on the slide that links the slide with other information about the slide (e.g., a customer, location, health symptoms, and sample type). The barcode may be used to automate where to look on the slide to locate the particulates from the sample.

Samples may be imaged using a wide range of different imaging techniques and at a wide range of different zoom levels. Example scanners or imagers that may be used include a digital microscope, bright-field microscope, polarized imager, phase contrast image, fluorescence imager, scanning electron microscope, dark-field microscope, or other types of scanners/imagers. During scanning or imaging of the sample, the scanner (such as a digital microscope) may be used to scan or image the whole area where the sample is located (e.g., where any mold particulates or other materials are located). These obtained images may be quite large in pixel count and memory size. For example, the images may be in full color (16-bit, 24-bit, 32-bit or more) with extremely high resolution (pixel count and/or dots per inch). In one embodiment, the imaging/scanning process obtains not only images of the whole area, but also images at different resolutions. For example, the sample area may be divided up into a grid of smaller sized areas, which are each imaged at a high zoom level and then multiple grid areas may be imaged together at a lower/wider zoom level. Different zoom levels may be helpful in imaging/identifying varied sizes of particulates or detecting details for identifying different material types. For example, a single sample may include particles of varied sizes that would be helpful to detect and identify.

After imaging, the resulting digital images may be stored or associated with a serial number identifying the location where the sample was taken, a customer that obtained the image samples, or any other information about the location, sample, type, study type, medical conditions, or the like. The digital images may be stored and transmitted to a cloud storage or remote storage location for training, analysis, classification, association, or aggregation with other data, or the like. For example, the lab may acquire the images and upload them to a file server. The file server may include a listener that detects the uploading of new images and uploads those to a remote classification system for classification, storage, reporting, and/or sharing. Related data may also be uploaded with the image for storage at a remote or cloud location. Custody tracking of the sample, digitized images, and associated data may be provided to ensure security and accuracy of the data. In one embodiment, images, customer information, health information, or the like may be associated with a common serial number or other identifier so that correlations between various data can be determined.

Data stored in the remote or cloud storage may include data, including images and related data, from many different labs, customers, locations, or the like. The stored data may be accessible to a classification system that includes a classification model, neural network, or other machine learning algorithm. The classification system may classify each image (or sample associated with the image) as including a particular type of particle. For example, the classification system may analyze each image to classify or detect particles within the images. A particle may be classified as a specific genus or species of mold spore, or other particle type. For example, the classification system may generate a heat map for an image indicating which regions of the image include diverse types of particles.

As another example, the classification system may generate proposal regions and then detect/classify particles in them. For example, the proposal regions may indicate areas where there is likely something to be present (e.g., a mold spore) to be classified or detected. This may allow analysis or processing of only portions of the image using a neural network or algorithm to locations where particles or materials are present and ignoring regions where there are no particles. For example, large regions of an image may be blank or white space where no particles are present. Processing blank or white space regions using neural networks may be a waste of computing resources. The image processing algorithm or neural network used by the classification system may include a system trained based on human classified images or samples. For example, the neural network may be trained using supervised learning. In one embodiment, learning and training may be performed using unsupervised machine learning.

In one embodiment, the classification system may provide one or more images (or portions of images) of samples to users for classification. For example, previously classified or unclassified images may be provided to one or more experts for classification. The experts may provide their own classification, which may be used to either confirm or change an original classification. The machine learning algorithms, models, or neural networks may be retrained based on the updated classifications to further improve machine learning models and algorithms. In one embodiment, changes to classifications for specific particles or images may be tracked. Tracked classifications may provide additional data about the accuracy of classifications and can lead to further refinement in machine learning and classification algorithms and models.

Based on classification of particles within samples, reports may be generated for the type of study that is being performed for a location, patient, or customer. The report may be generated based on the classification of particles within images of samples, particle counts for different particle types, health conditions related to the presence or counts for specific particle types, or the like. The report may be automatically generated specific to the serial number, customer, and/or location associated with the images and the corresponding sample. In one embodiment, a report may include a report for the types of particles detected, the number of particles, likely conditions in the sampled environment or patient, recommended steps to be performed, or the like. The report may be provided as a general report for a specific particle type or may be more general to health or conditions for a sample environment.

As used herein, the term “particle” is given to mean any small unit or portion of material such as dust, mold sports, cells or groups of cells, fibers, viruses, small chunks of materials, organism(s), tissue, biological matter, minerals, or any other item or material discussed herein as being classified or detected. Additionally, the classification, detection, or identification of particles may include identifying a specific type of particle or condition of a specific particle or material.

The systems and methods described herein provide significant utility and benefits. For example, automated particle classification, report generation, and/or the like may significantly reduce expert time and/or errors (such as typographical errors), thereby increasing efficiency and accuracy. At least some embodiments disclosed herein enable the full classification of each particle within a whole sample. Generally, technicians do not have enough time, nor are they required, to analyze every particle or the full sample for particle type or classification. Additionally, it can take a large amount of time for a technician to perform particle analysis and classification within a sample. This time can be saved by using machine learning algorithms and/or deep neural networks for automated computer or machine learning classification. Accuracy may be increased because a greater portion of the slide (or sample) is analyzed and because embodiments of machine learning algorithms or models may provide greater classification accuracy for a particle type and even for a larger number of different particle types.

The systems and methods described herein allow for the long-term storage and use of samples because they are stored as digitized images and stored in a central location. Machine learning algorithms may be refined based on the large corpus of data and thus improved particle identification algorithms and machine learning results may be obtained. Error in report creation may also be decreased because typographical errors by humans may be reduced or eliminated. For example, even if a generated report is modified by a human user or technician after generation, the report details may reduce the chance of filling out a report with information from an incorrect sample, customer, location, or the like. Furthermore, the tracking of the movement of the sample, digital images, associated health or location data, changes in particle classification, or the like may lead to quicker and more accurate reporting to clients. Additionally, more accurate tracking may lead to less management overhead and reduce the amount of time it takes to place a process in a final state so that a report and/or bill may be sent to a customer. Thus, a larger number of customers may be served, and even better identification and reporting results may be obtained.

In some cases, distinctions between different particles, or distinctions between different classifications of the same particle type may not be detectable visually for humans. Because existing classification methods for particles depend on human classification using the same channel as the human (e.g., visual detection/classification based on an image), existing systems and methods are unable to distinguish between particles that are indistinguishable to humans.

Numerous examples and embodiments disclosed herein include neural networks as a computer model for machine learning, training, and/or classification. Although neural networks may be used in at least some embodiments, one of skill in the art will recognize that other types of computer models, statistical models, or machine learning models may be used instead. Thus, neural networks are used as one example of a model and the disclosure is not limited to neural networks. A detailed description of systems and methods consistent with embodiments of the present disclosure is provided below. While several embodiments are described, this disclosure is not limited to any one embodiment, but instead encompasses numerous alternatives, modifications, and equivalents. In addition, while numerous specific details are set forth in the following description to provide a thorough understanding of the embodiments disclosed herein, some embodiments may be practiced without some or all these details. Moreover, for the purpose of clarity, certain technical material that is known in the related art has not been described in detail to avoid unnecessarily obscuring the disclosure.

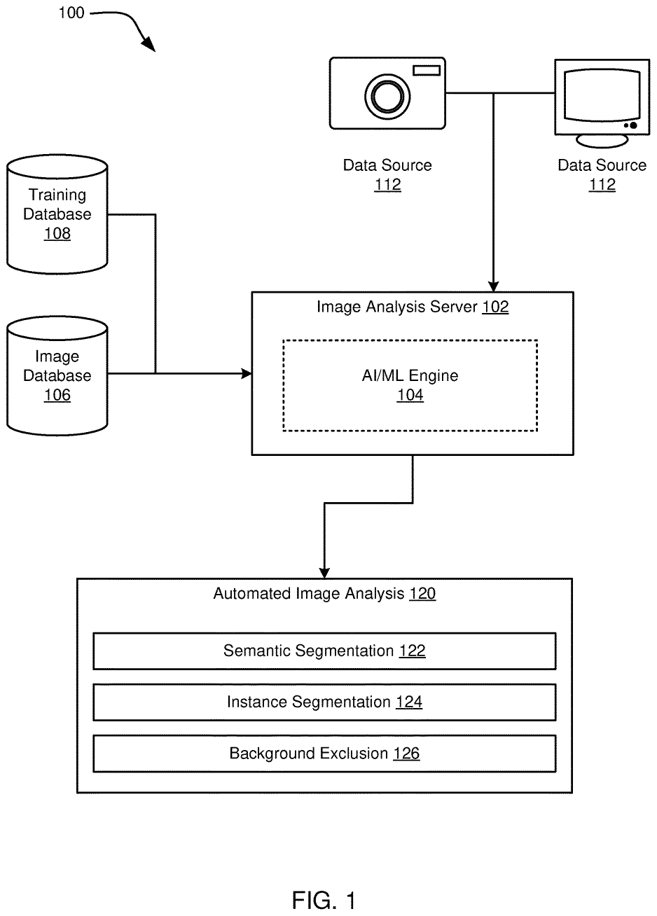

Referring now to the figures, FIG. 1 is a schematic diagram of a system 100 for image analysis and secure cloud-based storage and communication of imaging data. The system 100 includes an image analysis server 102 that comprises an artificial intelligence and/or machine learning (AI/ML) engine 104 and/or is in communication with the AI/ML engine 104. The image analysis server 102 executes automated image analysis 120 according to one or more image processing protocols as described herein, including semantic segmentation 122, instance segmentation 124, and background exclusion 126.

The image analysis server 102 acts as the centralized processing hub and receives imaging data from one or more connected data sources 112. On the consumer and enterprise side, the data sources 112 may include desktops, laptops, tablets, smartphones, and so forth, and may specifically include data sources 112 capable of submitting photographs, screenshots, or video frames either in real time or as batch uploads. Beyond personal devices, the image analysis server 102 may additionally ingest data from dedicated visualization hardware such as medical and diagnostic imaging systems. These imaging systems may include, for example, microscopes, X-ray detectors, MRI scanners, CT imaging systems, ultrasound probes, endoscopic cameras, digital pathology slide scanners, and so forth.

The AI/ML engine 104 and/or the image analysis server 102 are in communication with a database comprising training database 108 for training the AI/ML engine 104. The image analysis server 102 is further in communication with an image database 106 that stores images to be assessed by the AI/ML engine 104. The imaging information stored in the image database 106 may be ingested from the one or more data sources 112.

The image analysis server 102 implements protocols for protecting patient data and patient imaging. The image analysis server 102 implements a layered set of security protocols at every stage of the data lifecycle. At the transmission level, all incoming image data is encrypted in transit using protocols such as TLS to ensure that sensitive content cannot be intercepted as it travels across networks. Once received, data at rest is encrypted using strong standards such as AES-256 with encryption keys managed through dedicated key management systems. Access to patient images and associated metadata is tightly controlled through role-based access control (RBAC), ensuring that only authorized personnel can view or interact with specific records. The image analysis server 102 may implement multi-factor authentication to add an additional layer of identity verification and reduce the risk of unauthorized access if credentials are compromised.

Beyond encryption and access control, the image analysis server 102 is further designed to comply with regulatory frameworks such as HIPAA in the United States, GDPR in Europe, and other regional health data protection laws. This includes maintaining detailed audit logs that record every instance of data access, modification, or transmission to provide a traceable chain of custody for each patient record. The image analysis server 102 may implement data minimization practices, such that only necessary data is retained in the image database 106. The image analysis server 102 may automatically remove identifying information from any images included in the training database 108 for the AI/ML engine 104.

The training database 108 is a repository of test information, imaging datasets, and training datasets for the AI/ML engine 104. The image analysis server 102 may access the training database 108 by way of an Application Program Interface (API). The API allows the image analysis server 102 to receive automatic updates from the training database 108 as needed. In an embodiment, the training database 108 is integrated on the image analysis server 102 and is not independent of the storage and processing resources dedicated to the image analysis server 102.

The training database 108 may include images and scans of slides that include biological matter to be assessed. The slides and other information may be received from a user, customer, technician, or other entity that has obtained and forwarded one or more samples. For example, a lab worker may receive the one or more slides and load the slides into a scanner for imaging. In one embodiment, the lab worker may scan a barcode on the slide that links the slide with other information about the slide (e.g., a customer, location, health symptoms, and sample type). The barcode may be used to automate where to look on the slide to locate the particulates from the sample. For example, the barcode may identify a manufacturer, customer, or party or entity that obtained the slide because the manufacturer, customer, or party or entity that obtained the slide may indicate where the sample is located. In some cases, it can be difficult to locate particulates on a slide, such as mold spores, if you do not know where the sample was placed on the slide. For example, the slide may be much larger than the actual sample, so it is often efficient to only scan/image the portion of the slide where the particulates are located. Knowing the entity, customer, or slide manufacturer (or brand) may allow a scanning system to automate location and scanning of the relevant portion of the slide.

Samples may be imaged using a wide range of different imaging techniques and at a wide range of different zoom levels. Example scanners or imagers that may be used include a digital microscope, bright-field microscope, polarized imager, phase contrast image, fluorescence imager, scanning electron microscope, dark-field microscope, or other types of scanners/imagers. During scanning or imaging of the sample, the scanner (such as a digital microscope) may be used to scan or image the whole area where the sample is located (e.g., where any particulates or other materials are located). These obtained images may be quite large in pixel count and memory size. For example, the images may be in full color (16-bit, 24-bit, 32-bit or more) with extremely high resolution (pixel count and/or dots per inch). In one embodiment, the imaging/scanning process obtains not only images of the whole area, but also images at different resolutions. For example, the sample area may be divided up into a grid of smaller sized areas, which are each imaged at a high zoom level and then multiple grid areas may be imaged together at a lower/wider zoom level. Different zoom levels may be helpful in imaging/identifying assorted sizes of particulates or detecting details for identifying different material types. For example, a single sample may include particles of varied sizes that would be helpful to detect and identify.

After imaging, the resulting digital images may be stored or associated with a serial number identifying the location where the sample was taken, a customer that obtained the image samples, or any other information about the location, sample, type, study type, medical conditions, or the like.

Data stored in the remote or cloud storage, such as the image database 106 or the training database 108, may include data, including images and related data, from many different labs, customers, locations, or the like. The stored data may be accessible to a classification system that includes a classification model, neural network, or other machine learning algorithm. The classification system may classify each image (or sample associated with the image) as including a particular type of particle. For example, the classification system may analyze each image to classify or detect particles within the images. A particle may be classified as a specific genus or species of mold spore, bacteria, virus, or other particle type.

The image analysis server 102 executes automated image analysis 120 on data ingested from data sources 112, which may specifically include medical or diagnostic visualization systems. The image analysis server 102 may specifically execute one or more image processing protocols as described herein, including semantic segmentation 122, instance segmentation 124, and background exclusion 124.

The semantic segmentation 122 includes assigning a categorical label to each pixel within an image frame. The semantic segmentation 122 output is a dense, pixel-wise map of the semantic content of the input image frame. Unlike object detection methods that approximate object locations using bounding geometries, semantic segmentation 122 operates at the finest level of spatial granularity and enables precise delineation of regions corresponding to distinct object classes such as, but not limited to, anatomical structures, pathological regions, background tissue, or foreign bodies within an image.

The instance segmentation 124 combines object detection and semantic segmentation 122 to identify and delineate each individual object in an image at the pixel level. Unlike semantic segmentation 122, which classifies every pixel into a category without distinguishing between separate objects of the same class, instance segmentation 124 assigns a unique label to each distinct object instance, even when multiple objects of the same type overlap or are in close proximity. For example, in an image containing several people, instance segmentation 122 recognizes all pixels belonging to a “person” classification, and additionally outlines each individual person as a separate entity.

The background exclusion 126 includes separating foreground objects from background. This is utilized to isolate the foreground objects, suppress the background, and focus image analysis processing on regions of interest. With background exclusion 126, every region within the input image frame belongs to the foreground (i.e., the one or more objects of interest) or the background (i.e., everything else). Background exclusion 126 aims to distinguish between the two to enable the AI/ML engine 104 to handle them independently and reduce overall processing requirements.

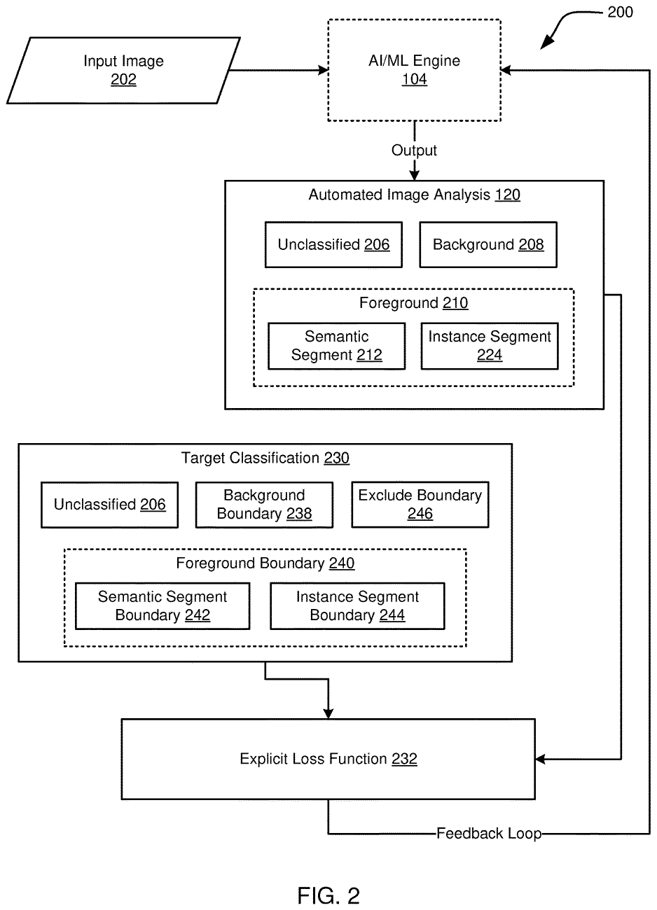

FIG. 2 is a schematic block diagram of a system and process flow 200 for training or optimizing the AI/ML engine 104 to perform the automated image analysis 120. The process flow 200 includes providing an input image 202 to the AI/ML engine 104. The AI/ML engine 104 executes automated image analysis 120 to classify various regions within the input image 202. This includes distinguishing between three top-level classes, including unclassified 206, background 208, and foreground 210. The unclassified 206 regions include pixel data that the AI/ML engine 104 ignored based upon training and/or the AI/ML engine 104 could not confidently assign. The background 208 regions include pixel data deemed irrelevant to the analysis. The foreground 210 regions include pixel data that should undergo further analysis, and may specifically include pixel data of biological or diagnostic interest. The foreground 210 classification may be divided into two types, including semantic segments 212 that classify regions by category without distinguishing individual instances, and instance segments 224, which classify regions by category and additionally delineate individual objects of interest within that category.

The result of the automated image analysis 120 may be compared against a target classification 230 to calculate an explicit loss function 232. The target classification 230 includes the imaging data from the input image 202 and additionally includes user-drawn boundaries identifying background, foreground, and exclusion regions. The target classification may include unclassified 206 regions that have no user-drawn boundary. The target classification 230 may additionally include background labels 238 drawn around explicit background 208 regions, exclude labels 246 drawn around labels that should be excluded from analysis by the AI/ML engine 104, and foreground labels 240 drawn around foreground 210 regions. The foreground labels 240 may include semantic segment labels 242 that classify specific regions under a certain categorical label without distinguishing individual instances. The foreground labels 240 may additionally include instance segment labels 244 that classify specific regions under a certain categorical label, and additionally identify unique and separate instances of objects of interest under the same categorical label.

The explicit loss function 232 is a mathematical measure of how different the automated image analysis 120 output is from the target classification 230. The explicit loss function 232 is utilized to train and optimize the AI/ML engine 104. The explicit loss function 232 represents the error between the AI/ML engine's 104 error between the automated image analysis 120 prediction and the ground truth labels in the target classification 230. The explicit loss function 232 is utilized in a feedback loop to train and optimize the image analysis model executed by the AI/ML engine 104. This represents an iterative training process by which the model's weights are continuously updated to improve classification accuracy over successive training cycles.

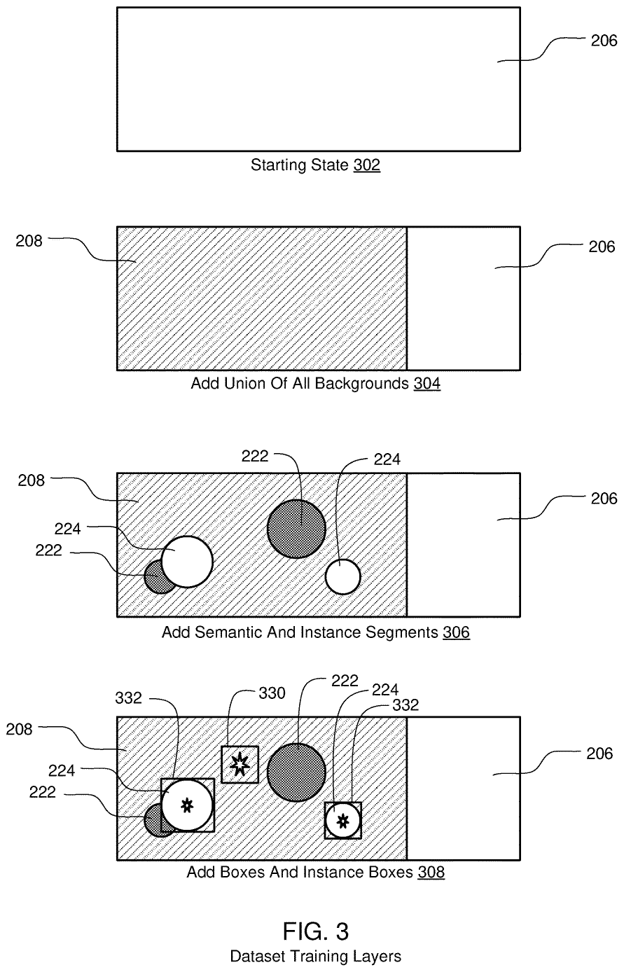

FIG. 3 is a schematic illustration of dataset training layers for training the AI/ML engine 104. Within the objects layers, objects interact depending on which type of object they are. The objects identified by the AI/ML engine 104 according to the automated image analysis 120 include unclassified 206, background 208, and foreground 210 objects. The foreground 210 objects may include semantic segments 212 or instance segments 214. Each layer illustrated in FIG. 3 is processed independently.

FIG. 3 illustrates a starting state 302 comprising only unclassified 206 pixel data. FIG. 3 additionally illustrates a state 304 wherein union of all backgrounds is added to the starting state 302. This state 304 includes the unclassified 206 pixel data and additionally include background 208 pixel data.

FIG. 3 additionally illustrates a state 306 wherein semantic and instance segments are added to the background. This state 306 includes the unclassified 206 pixel data, the background 208 pixel data, and additionally includes foreground objects (see 210). The foreground objects may include semantic segments 212 and instance segments 214. Because semantic segments 212 and instance segments 214 overlap, these regions can be in conflict.

FIG. 3 additionally illustrates a state 208 wherein boxes and instance boxes are added. This state 308 includes the unclassified 206 pixel data, the background 208 pixel data, the semantic segments 212 and the instance segments 214, and additionally includes boxes 330 and instance boxes 332. Because box centers can conflict between regular boxes 330 and instance boxes 332, they may be marked by the AI/ML engine 104 as unclassified 206.

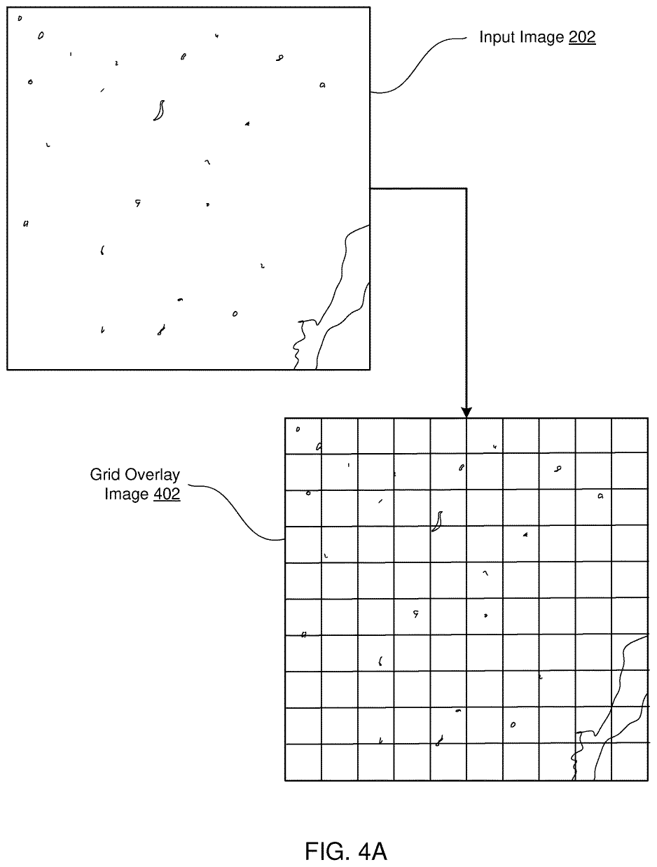

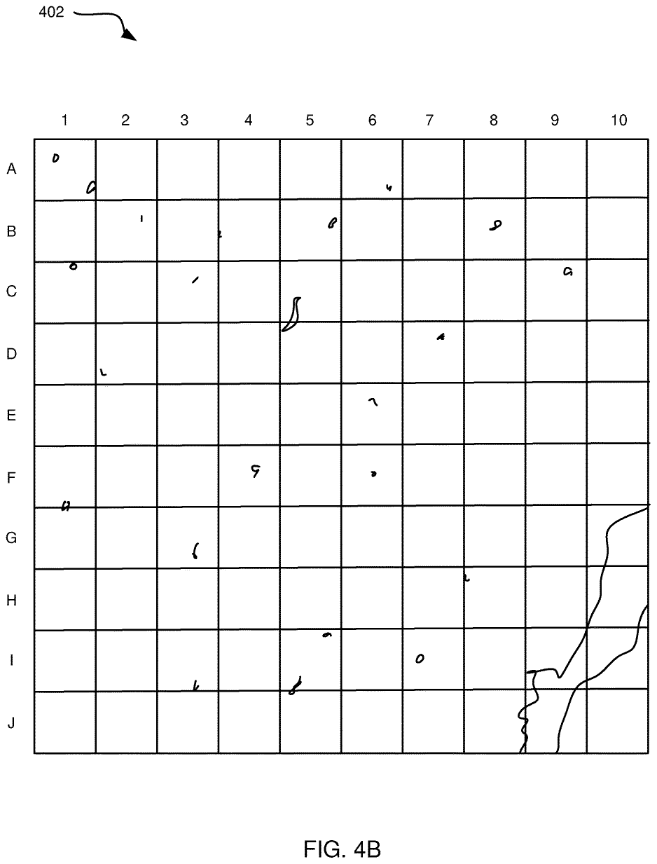

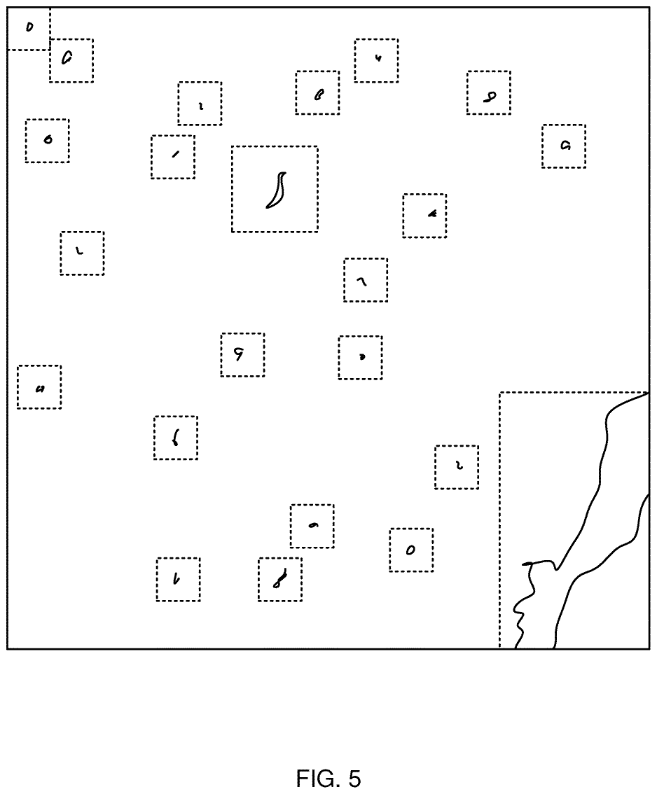

FIGS. 4A and 4B illustrate an image that undergoes object detection and object classification as described herein. FIGS. 5-9 illustrate an image-by-image process flow for executing the object detection and object classification on the image first pictured in FIGS. 4A-4B.

The process flow illustrated in FIGS. 5-9 may be referred to as a YOLO (You Only Look Once) machine learning model for object detection. The object detection pipeline utilizes YOLO to learn how to detect objects of interest given previously labelled objects the AI/ML engine 104 has seen before. YOLO views the images as an S×S grid. Each grid cell learns to predict whether an objects exists within its cell, and if there is an object, the AI/ML engine 104 defines a boundary around the object and classifies the object.

The YOLO model depicted in FIGS. 5-9 is trained using images with boxed and labeled objects. These training images are fully classified, meaning that each object of interest within the image has been boxed and labeled. With a quality dataset, the AI/ML engine 104 learns to proficiently box and classify objects after looking at scenes a sufficient quantity of times. The most efficient way to improve the AI/ML engine 104 is to label additional data (i.e., provide additional training images) or clean the existing dataset. Any misclassified or improperly boxed objects present within the training dataset will decrease the performance of the AI/ML engine 104.

FIG. 4A is a schematic illustration of an example image for classification. As shown in FIG. 4A, the input image 202 is partitioned into a plurality of grids to generate the grid overlay image 402. The grid overlay image 402 is then processed with a machine learning algorithm (such as the AI/ML engine 104) to identify, box, and classify the objects within the input image 202.

The example input image 202 utilized in FIGS. 5-9 is a microscopy view of biological material such as viruses, bacteria, mold spores, cells, and so forth, which can be challenging to classify with a machine learning algorithm. Typical slide images include diverse types of cells or other objects of interest with different class types. Most cell types correspond to a kind of cell, parasite, or bacteria, but may include other kinds of objects. Microscope images typically include occluded image data, out-of-focus regions, mislabeled objects, and can be very dense with numerous types of objects close to one another. In some cases, images depicting biological material are analyzed to identify and quantify the presence of rare cells such as specific viruses, bacteria, fungi, and so forth. In many cases, an image of a slide will include a few instances of rare cells and will include many more instances of “background” cells that are not being identified.

The input image 202 is captured by an image sensor and may specifically be captured by an image sensor associated with a microscope or other device used for magnification. The input image 202 may include a down sampled (lower resolution) version of an original image or it may be a cropped portion of the original image. The input image 202 may include the original, full-resolution capture.

In some cases, a slide scan includes more detail than needs to be classified. In these cases, the slide scan may be cropped to a classification region, and this classification region is then fed as the input image 202. The classification region is typically drawn by a user that manually specifies which area should be classified. Classification regions supersede any zone classifiers that attempt to determine what part of the scan should be classified. If a scan has no classification region, the entire scan is fed in the AI/ML engine 104 as the input image 202. A classification region may be as small as a 1×1 pixel box.

Classification regions have an optional filter that specifies only specific classes to be uploaded to the AI/ML engine 104. If there are overlapping filtered classification regions, the overlapped area will return objects that match either of the two filters.

If there is a classification region on the slide scan, then all foreground class and anti-class ground truth labels outside of the classification region will be considered inferred classification regions, which means the classifier (typically a user) should attempt to classify that label as if a filtered classification region the same size as the label were present. That is, no false positives will be identified for objects that intersect the ground truth label. Objects inside a filtered classification region that do not match the filter are considered an inferred classification region and therefore follow the overlap rules described herein.

Proposed objects that are both wholly within a classification region and do not have a ground truth match will be uploaded and counted as a false positive. Proposed boxes that have a matching ground truth will be uploaded and counted in the metrics. Proposed boxes that are now wholly contained in a classification region and do not match a ground truth will not be uploaded or counted.

The input image 202 is partitioned with a grid to generate the grid overlay image 402. In the example illustrated in FIG. 4A, the input image 202 comprises a depiction of a plurality of particles, which may include, for example, mold spores, bacteria, viruses, cells, fibers, non-organic matter, and so forth. The grid overlay image 402 includes the input image 202 with a grid overlaid thereon. The grid may include a plurality of squares as illustrated in FIG. 4A, or it may include other shapes, as necessary. Additionally, the grid may include an equal number of squares along an x-axis when compared with the number of squares along the y-axis. Alternatively, the grid may include a non-equal number of squares along the x- and y-axes. The grid is overlaid on the input image 202 such that the particles depicted in the input image 202 are located within one or more grid squares.

FIG. 4B is a schematic illustration of the grid overlay image 402. The grid overlay image 402 may be partitioned such that each grid unit (the squares in the example illustrated in FIG. 4B) is identifiable with a unique name. For example, the grid units across the top row may be named A1, A2, A3, A4, A5, A6, A7, A8, A9, and A10, and the grid units across the second row may be named B1, B2, B3, B4, B5, B6, B7, B8, B9, and B10, and so forth. The plurality of square grids within the grid overlay image 402 may be preferrable to simplify the grid overlay and simply the naming of each grid unit. However, it should be appreciated that other grid geometries may be used without departing from the scope of the disclosure.

FIG. 5 is a schematic illustration of the input image 202 with anchor boxes around each particle to generate an anchor box image. In some cases, the systems, methods, and devices described herein do not generate a complete anchor box image and instead place anchor boxes around only a selection of particles within the input image 202.

The AI/ML engine 104 is trained on a training dataset that classifies objects into one or more classifications according to a labeling protocol (see target classification 230). The labeling protocol includes one or more of an unclassified 206 region (i.e., a region that does not have any explicit label), a background boundary 238, an exclude boundary 246, or a foreground boundary 240. The foreground labels 240 may specifically include semantic segment labels 242 or instance segment labels 244. The labeling protocol may further include anti-class classifications, merge classifications, and ignore classifications. During training, the AI/ML engine 104 maps classifications to cell type categories such that each classification may be treated differently for each training run.

In the training dataset and during model classification, foreground objects include objects of interest that the AI/ML engine 104 must accurately detect to assist a pathologist or technician in making a slide-level determination. The goal is to detect foreground objects consistently and precisely and then upload those detections and counts for review.

Typically, foreground objects must be smaller than the size of the scene. If the scene includes large objects for classification, the recommended approach is to only a box a portion of the large object. For example, the AI/ML engine 104 may box the head of a work or the nucleus of a large cell. As with all foreground objects, the AI/ML engine 104 defines a means to consistently box them. If there is more than one way to box the subsection of the object, the AI/ML engine 104 will experience issues when defining an object-level holdout, and this will create interference with training the AI/ML engine 104.

When adding a background class is not enough to weed out visually similar objects from detected as foreground, the AI/ML engine 104 may classify a background as an anti-class. This explicitly forces the AI/ML engine 104 to learn to separate the foreground class from its confusion pair background class. For the purposes of training, anti-class objects are treated as foreground objects except they are treated as background for reporting. Anti-class proposals at classify time are either configured as an expert-only cell type and uploaded, or are not uploaded at all depending on debug, database, and customer needs. Anti-class proposals found at object level holdout time may be uploaded if they match ground truth boxes, and not if they are classified as false positives. Typically, anti-classes have the same size constraints discussed in connection with foreground classes.

The AI/ML engine 104 is trained not to predict boxes on background 208 areas of each scene. This is accomplished by adding background labels 238. When the AI/ML engine 104 sees a background boundary 238 it learns to not predict boxes at that location. Background labels 238 inhibit box prediction while foreground labels 240 encourage box predictions. Anything within a background boundary 238 that is foreground 210 must be classified or excluded.

During training, if an exclude boundary 246 contains the center of a pixel data encircled by a foreground boundary 240, then the pixel data within the foreground boundary 240 is treated as if it does not exist. Further, if a background boundary 238 overlaps with an exclude boundary 246, then only pixel data within the overlapping region of the background boundary 238 is ignored. Exclude objects are segmented into intuitive classes. For example, blurry foreground objects should be in one exclude class, while foreground objects whose classification is not known should go into another exclude class.

Boxes in training that are not verified may be treated as exclude labels 246 because they represent an elevated risk to be something of interest, and therefore potentially mislabeled. Further, unverified labels are intended to be a temporary state until an expert (human) has a chance to verify the label so it is not expected that there will be an overabundance of unverified boxes causing issues when training the AI/ML engine 104.

The configuration file for training the AI/ML engine 104 has fields to specify background classes, ignore classes, and exclude classes. Any other cell type contained in the classmap automatically becomes foreground if it has some minimum number of boxes.

Objects that match an excluded object from a ground truth are removed from the metrics output by the AI/ML engine 104. Objects that are fully contained within an excluded region are also removed from the metrics.

Classes can be combined before or after they are presented to the AI/ML engine 104, depending on the desired effect. To implement a pre-model merge, multiple cell types can be merged into one model class. This is common when the differentiation is not important but combining classes improves accuracy. This may also be useful when there are several variations of a classification, and each should be split to ensure it receives proper representation. For example, schistocytes in blood have many variations including “small fragment” and “helmet.” To ensure the AI/ML engine 104 has adequate coverage for both variations, they may be labeled separately in the training dataset, and then merged together before the training dataset is provided to the AI/ML engine 104.

Multiple model types may be combined into one cell type. This may be helpful if there are distinct types of objects that each count toward the same final object type. The AI/ML engine 104 can learn each object type separately and then combine the results.

The training dataset may additionally include ignored classes. This may occur when objects are labeled but are not wanted in the training dataset or holdout. These ignored objects should be treated as if they do not exist. A common example of this is to do a brief experiment to exclude a class to measure its impact. Configuring a class to be an ignored class is a simplified means to facilitate this. In a comparison view, ignored objects within the holdout are treated as if they do not exist, and thus they have no bearing on the comparison view.

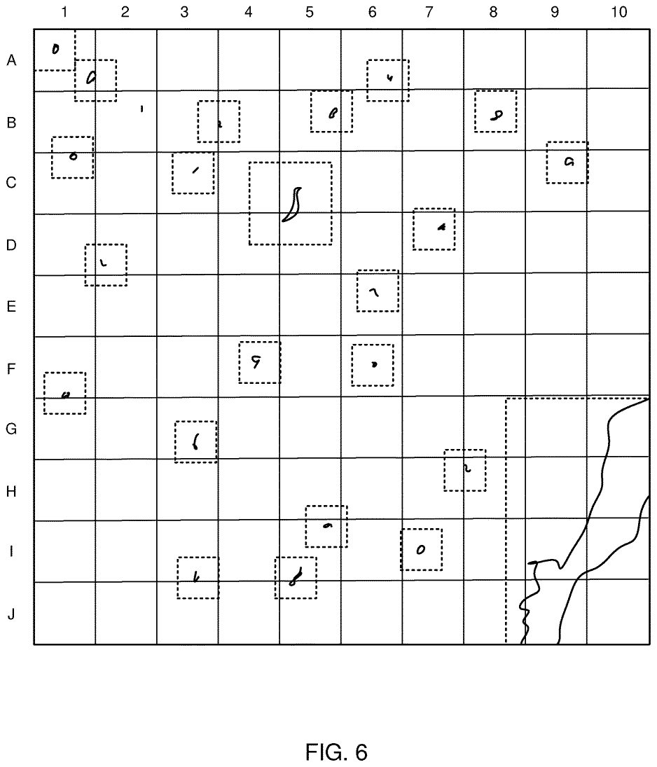

FIG. 6 is a schematic illustration of the grid overlay image comprising anchor boxes around particles within the image. The input image 202 is fed to the AI/ML engine 104 that is configured to analyze the input image 202 grid-unit-by-grid-unit such that the neural network individually assesses each grid unit within the grid overlay image. In some cases, a grid unit is a one-by-one grid such that each grid unit is a single pixel. In other cases, grid units may include numerous pixels. The neural network will perform each individual assessment based on the image as a whole, rather than only the image data located within a particular grid unit.

For example, the neural network first analyzes grid unit A1 to determine the following: (a) an x-coordinate for grid unit A1; (b) a y-coordinate for grid unit A1; (c) a width of grid unit A1; (d) a height of grid unit A1; (e) a determination of whether grid unit A1 includes an object of interest. The neural network is trained to identify and classify certain objects of interest and may be trained to ignore other objects within the image. In an example implementation, the neural network is trained to classify microscopy slides, and the neural network is trained to disregard common particles. The neural network may be trained to identify and classify only certain rare particles that may be present within the input image.

The neural network continues to analyze every grid unit within the grid overlay image to determine the x-coordinate, y-coordinate, width, height, and determination of whether the grid unit includes an object of interest. The neural network performs the per-grid unit analysis based on the image as a whole, rather than only analyzing the image data within the grid unit that is currently being analyzed. The loss function only is applied to grid units that overlap with ground truth labels by a configurable percentage. All other grids units are ignored by the loss function which means the AI/ML engine 104 does not learn from those areas of the scene. This allows labelers to exclude areas of the scene that contain ambiguous or overly numerous objects thereby creating a higher quality data set.

The neural network performs the following loss functions only on each grid unit with either a background or foreground label within the grid overlay image 402.

$${λ}_{coord} {\sum }_{i = 0}^{{S}^{2}} {\sum }_{j = 0}^{B} 1 {\frac{obj}{ij} [ {( {x}_{i} - {\hat{x}}_{i} )}^{2} + ( {y}_{i} - {\hat{y}}_{i} ) ]}^{2}$$

The variable S refers to each grid unit within the grid overlay image 402. The variable xᵢ refers to the ground truth x-coordinate location for the grid unit, and this is compared with the proposed x-coordinate location \hat{x}ᵢ. The same is performed for the ground truth y-coordinate location yᵢ and the proposed y-coordinated location ŷᵢ. If the neural network is incorrect, then the equation will generate some loss that will feed into back propagation.

$$+ {λ}_{coord} {\sum }_{i = 0}^{{S}^{2}} {\sum }_{j = 0}^{B} 1 \frac{obj}{ij} [ {( \sqrt{{w}_{i}} - \sqrt{{\hat{w}}_{i}} )}^{2} + {( \sqrt{{h}_{i}} - \sqrt{{\hat{h}}_{i}} )}^{2} ]$$

Again, this function is performed only on every grid unit with either a background or foreground label within the grid overlay image 402. This equation is performed on the ground truth width wᵢ and proposed width ŵᵢ, and further on the ground truth height hᵢ and proposed height ĥᵢ. If the neural network is incorrect, then the equation will generate some loss that will feed into back propagation.

$$+ {\sum }_{i = 0}^{{S}^{2}} {\sum }_{j = 0}^{B} 1 \frac{obj}{ij} {( {c}_{i} - {\hat{c}}_{i} )}^{2}$$

Again, this function is performed only on every grid unit with a foreground label within the grid overlay image 402. This equation determines whether the grid unit contains the center of the foreground label, or not. The variable c is the confidence that the grid unit comprises an object of interest. If the grid unit comprises an object, then the confidence score should be equal to one. If the neural network is incorrect, and the confidence score is less than one when the grid unit comprises an object, then the loss function will penalize the AI/ML engine 104 for this error. If the grid unit does not comprise an object, then the confidence score should be equal to zero. If the neural network is incorrect, and the confidence score is greater than zero, then the loss function will penalize the AI/ML engine 104 for this error.

$$+ {λ}_{no obj} {\sum }_{i = 0}^{{S}^{2}} {\sum }_{j = 0}^{B} 1 \frac{no obj}{ij} {( {c}_{i} - {\hat{c}}_{i} )}^{2}$$

Again, this function is performed only on every grid unit with a foreground or background label within the grid overlay image 402. This function compensates for the prior loss function to reduce the likelihood that the neural network will incorrectly indicate that a grid unit does not comprise an object. For every grid unit, if the grid unit is not the best-fitting anchor box that contains the center of a foreground label, then the neural network will learn to get close to a confidence level equal to zero. The neural network may likely assess many more grid units that do not comprise an object of interest than it will assess grid units that do comprise an object of interest. This may lead the neural network to be increasingly conservative and prone to indicating that a grid unit does not include an object of interest. The above function compensates for this tendency and is performed for cases when the grid unit does not include an object of interest (no obj).

$$+ {\sum }_{i = 0}^{{S}^{2}} 1 \frac{obj}{ij} {\sum }_{c classes} {( {p}_{i} ( c ) - {\hat{p}}_{i} ( c ) )}^{2}$$

This function is performed to determine when the neural network correctly classified the grid unit with a foreground label. When the neural network correctly classifies a grid unit that comprises an anchor box, then the function will result in no loss.

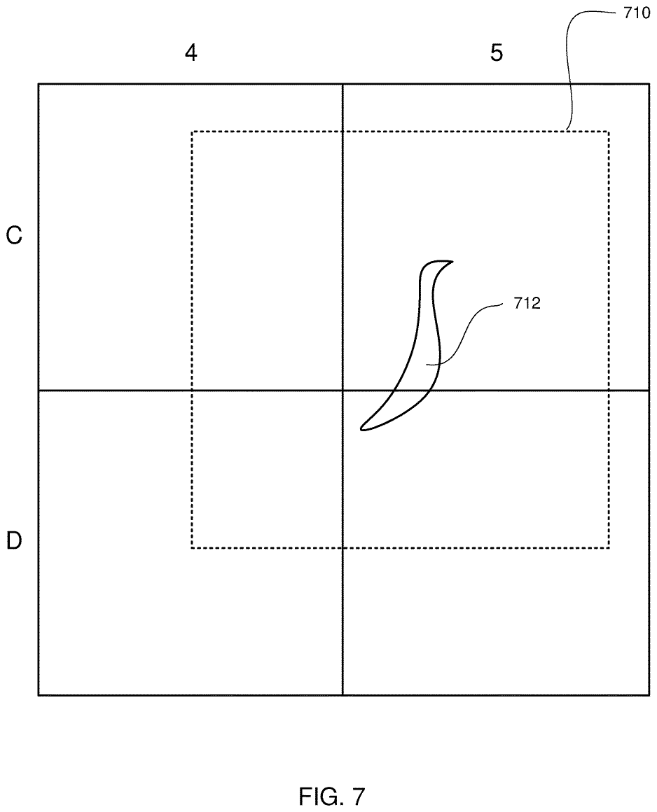

FIG. 7 is a schematic illustration of a particle 712 that is selected for analysis and classification. The particle 712 illustrated in FIG. 7 is the same particle illustrated in FIG. 6 that comprises an anchor box 710 touching each of grid units C4, C5, D4, and D5. The particle 712 itself is located within grid units C5 and D5, while the anchor box around the particle touches each of grid units C4, C5, D4, and D5. The neural network determines that each of C4, C5, D4, and D5 should comprise a portion of the anchor box 710 drawn around the particle 712.

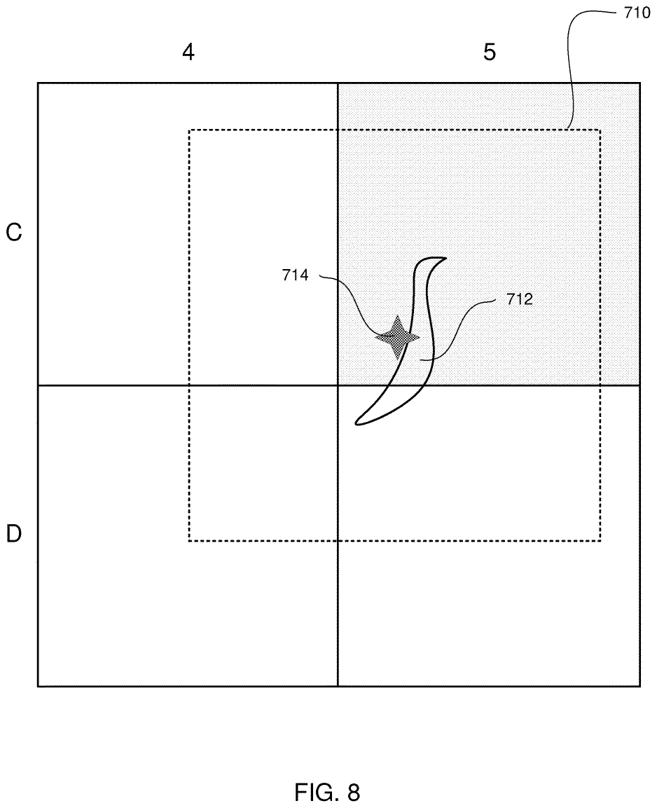

FIG. 8 is a schematic illustration of the particle 712 also illustrated in FIG. 7. The particle now comprises a center point 714 that denotes the center of the anchor box 710. The center point 714 is located within grid unit C5. For purposes of understanding, grid unit C5 is shaded in FIG. 8 to further indicate that the center point 714 of the anchor box 710 for the particle 712 is located within grid unit C5.

The machine learning algorithm described herein is performed on each grid unit C4, C5, D4, and D5 associated with the particle 712. The machine learning algorithm comprises identifying the center point 714 of the anchor box and then determining which grid unit comprises the center point 714. The machine learning algorithm affirmatively indicates that each of the other grid units (C4, D4, and D5) does not include the center point 714 of the particle 712.

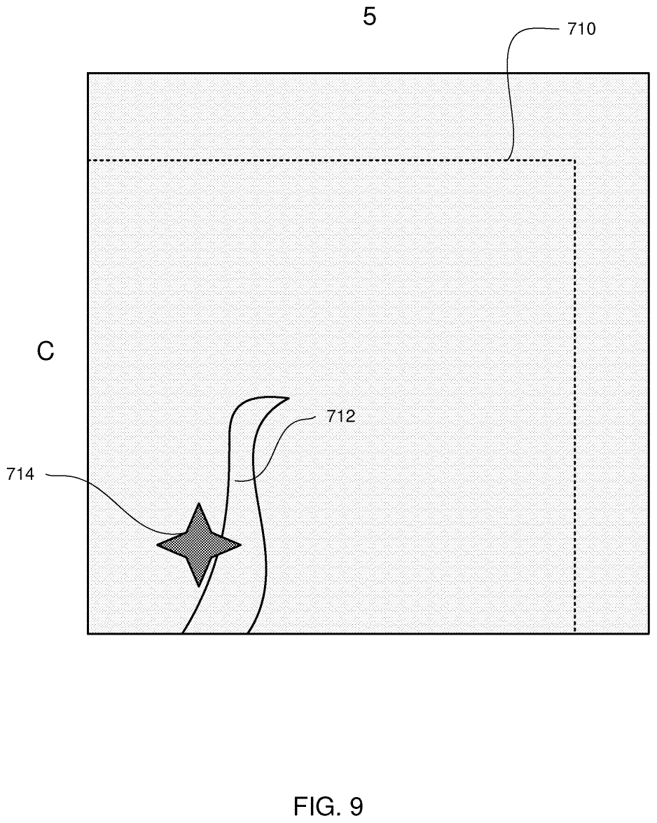

FIG. 9 is a schematic illustration of grid unit C5, including the portion of the particle 712 and the portion of the anchor box 714 that are located within grid unit C5.

As shown in FIGS. 5-9, classification is accomplished by dividing the input image 202 (i.e., the “classification region” of a slide scan or the entire slide scan) into PxQ “tiles.” Each of the tiles is sent to the AI/ML engine 104. The YOLO model predicts boundaries (see FIG. 5) and their classifications.

During classification, attributes allow for differentiating various groups within a cell type. An attribute could describe a certain kind of variation, or it could describe how in focus the cell is. Multiple attributes can help further describe an image beyond just its cell type. For example, a prominent use-case is with the VetFecal vertical, wherein each cell type has two attributes: “NonExemplar” and “Exclude.” For each foreground cell type, images that may not be completely in focus or partially obscured by another object are marked NonExemplar. Excluded images have something visible wrong with the object, for example, the object is cracked or otherwise undesirable. By labelling these images as Exclude, the AI/ML engine 104 will not propose new boxes around that object in the future but will also not learn from it. In this use-case, exemplary “Exemplar” images are not marked with either of these attributes. For VetFecal, using only exemplary images enabled the AI/ML engine 104 to obtain sufficient precise/recall with few images.

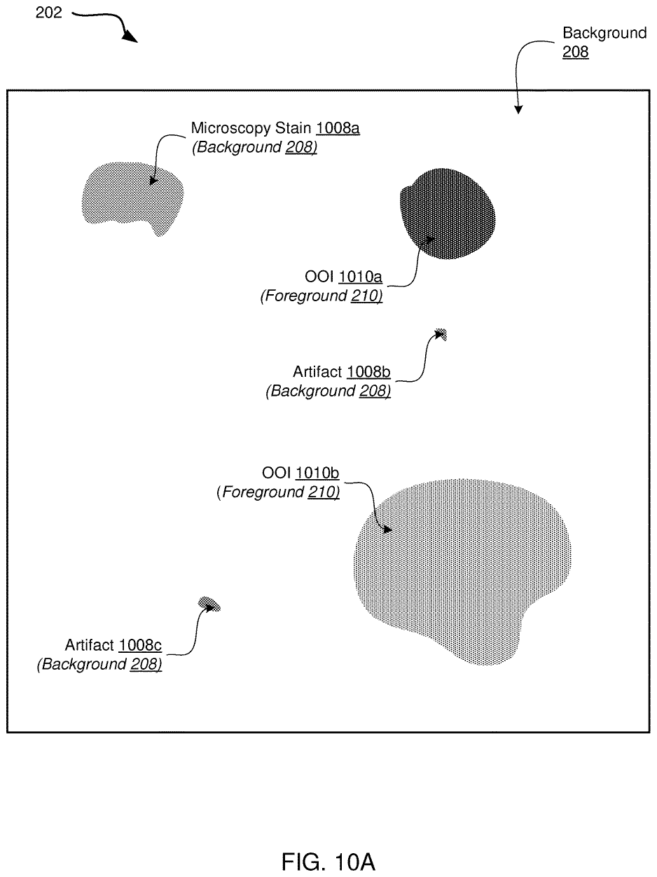

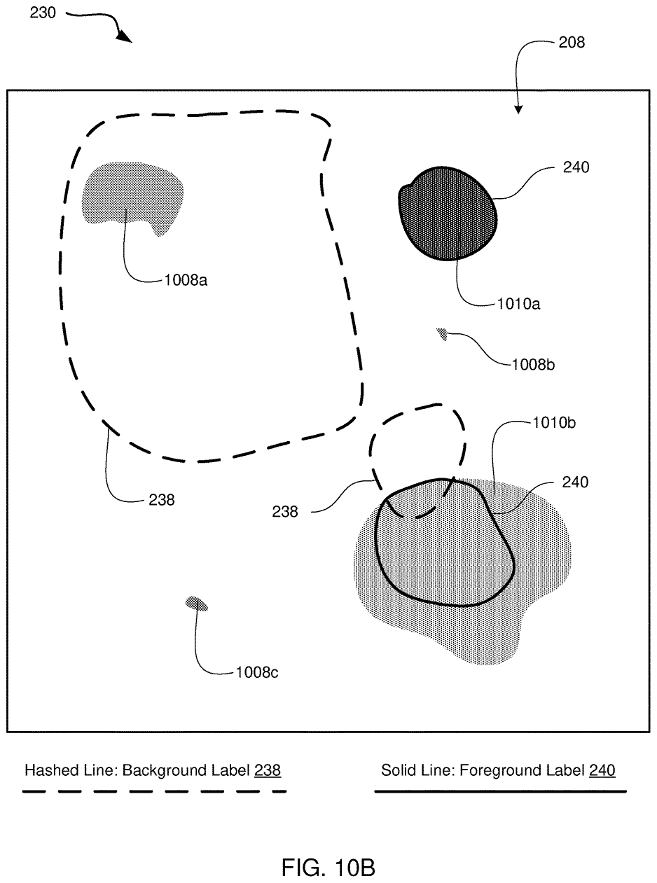

FIGS. 10A and 10B are schematic illustrations of an example input image fed to the AI/ML engine 104 to perform automated image analysis 120 and to further train and optimize the AI/ML engine 104. FIG. 10A illustrates the input image 202 as captured by the slide microscopy system. FIG. 10B illustrates a target classification 230 image comprising the input image 202 and additionally including labels that have been manually applied by a user to explicitly identify background and foreground components.

The example input image 202 is captured by a slide microscopy system and features several objects that may include cells, tissue structures, stroma, stains, microscopy artifacts, and so forth. Slide microscopy images present a uniquely difficult set of challenges for the AI/ML engine 104 that go beyond what most other imaging domains face when assessing road images, facial images, and so forth. The AI/ML engine 104 may particularly struggle to accurately classify slide microscopy images due to staining variability, focus variability, class imbalance between background and foreground tissues, biological heterogeneity, slide artifacts, a lack of standardized benchmarks, and so forth. Additionally, a whole slide image captured at high magnification may be significantly larger than standard images, and may include several gigabytes worth of data. The annotation and assessments procedures described herein improve the training and optimization of the AI/ML engine 104 by enabling users to quickly label ground truth images in a perfunctory manner that does not require precise or complete labeling of the background or foreground.

The input image 202 depicts numerous objects visualized by the slide microscopy system. Only a portion of these objects may be considered valuable for further assessment and thus classified as foreground 210. In some cases, certain visible objects, such as a globule of microscopy stain, may be irrelevant to clinical assessment and should thus be disregarded as background 208. In the example depicted in FIG. 10A, the input image 202 comprises background 208 around the objects, which is depicted as a plain white background in FIG. 10A. The input image 202 includes a microscopy stain 1008a object that should be classified as background 208. The input image 202 further includes a first artifact 1008b and a second artifact 1008c that should be classified as background 208.

The input image 202 additionally includes objects of interest (OOIs) that should be classified as foreground 210 and then undergo further assessment. The exemplary input image 202 illustrated in FIG. 10A includes a first OOI 1010a and a second OOI 1010b, and each of these should be classified as foreground 210. According to semantic and instance segmentation, these foreground 210 objects may each receive a categorical classification. The categorical classification may be set by a user, and they may have varying degrees of specificity, depending upon the goals for the AI/ML engine 104. The categorical classification options could include, for example: a cellular structure such as an individual cell, cell nuclei, cytoplasm, cell membrane, mitotic figures, and so forth; a tissue structure such as glands, ductal structures, tumor nests, blood vessels, nerve bundles, lymphoid follicles, muscle fiber bundles, connective tissue, and so forth; a pathological feature such as a necrotic region, inflammatory infiltrate, fibrotic region, calcification or mineral deposit, neovascularization, atypical cell, and so forth; or a staining-specific target such as a fluorescent marker region, DAB-positive region, PAS-positive region, trichrome-positive region, and so forth.

If the first OOI 1010a and the second OOI 1010b have the same categorical classification, then under semantic segmentation they would each be categorically classified but not separately identified. Thus, each of the first and second OOI 1010a, 1010b would be labeled as semantic segments (see 212). By contrast, under instance segmentation, the first and second OOIs 1010a, 1010b would be categorically classified and also identified as separate objects of the same category. Thus, each of the first and second OOI 1010a, 1010b would be uniquely classified as instance segments (see 214).

FIG. 10B illustrates the target classification 230 image, which comprises the input image 202 and additionally includes user drawn labels for identifying foreground and background. The target classification 230 is utilized to calculate the loss function (see 232) and optimize the image processing model executed by the AI/ML engine 104. In the example illustrated in FIG. 10B, the target classification 230 includes background labels 238 and foreground labels 240. It should be appreciated that the target classification 230 may include semantic labels and instance labels for identifying certain categorical classifications, and further for identifying separate objects of the same categorical classifications.

In FIG. 10B, the microscopy stain 1008a and surrounding background 208 are encircled by a background boundary 238. In this case, the user is explicitly indicating that microscopy stains 1008a like the one shown in FIG. 10B should be classified as background 208. This ensures that pixels located within the background boundary 238 will be considered background 208 when calculating the explicit loss function 232 for optimizing the AI/ML engine 104.

The first OOI 1010a is tightly and completely encircled by a foreground boundary 240. This foreground boundary 240 is applied precisely around the outer rim of pixels of the first OOI 1010a. This ensures that pixels located within the foreground boundary 240 are considered foreground 210 (or in more precise cases, semantic segments 212 or instance segments 214) in the explicit loss function 232 for optimizing the AI/ML engine 104. This type of labeling is painstaking and time consuming for users.

The background 208 artifacts 1008b, 1008c are not encircled by any label, and are thus unclassified. Pixels such as these that are not contained inside any labeling segment will not be considered in the explicit loss function 232. The AI/ML engine 104 is thus trained to ignore (i.e., not formally classify) this pixel data.

The second OOI 1010b is loosely labeled with the foreground boundary 240, such that only a portion of the second OOI 1010b is included within the foreground boundary 240. Additionally, a nearby background boundary 238 encircles a portion of the background 208 and additionally encircles a small portion of the second OOI 1010b. Foreground 210 segments override background 208 segments in the explicit loss function 232 when they overlap as shown with the second OOI 1010b. This means the boundary of the foreground boundary 240 divides the pixel labels between foreground 210 and background 208 where they overlap. This allows the AI/ML engine 104 to learn these boundaries without having to exactly specify or label them over the entire input image 202.

The exemplary target classification 230 labels shown in FIG. 10B enable a significant benefit over the prior art, because the background 208 and foreground 210 objects can be labeled in a perfunctory manner, and objects do not need to be tightly and completely encircled. This enables users to quickly label portions of objects without worrying about precise boundaries.

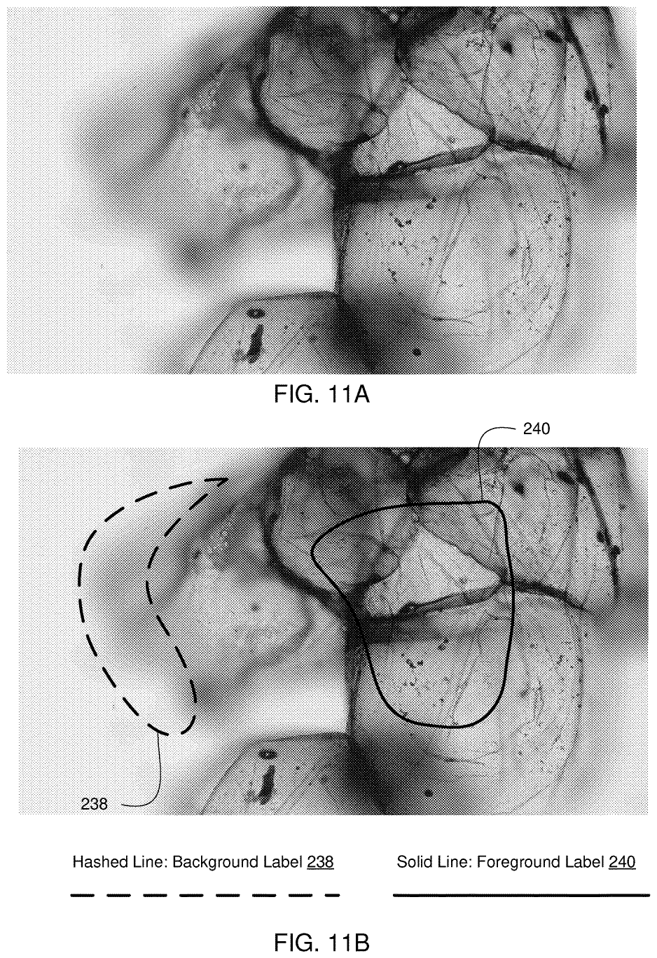

FIGS. 11A and 11B are images of an example input image fed to the AI/ML engine 104 to perform automated image analysis 120 and to further train and optimize the AI/ML engine 104. FIG. 11A illustrates the input image as captured by the slide microscopy system. FIG. 11B illustrates a target classification image comprising the input image and additionally including labels that have been manually applied by a user to explicitly identify background and foreground components.

FIGS. 11A-11B illustrate a cluster of cells that become increasingly blurry, such that there are no clear boundaries between blurry and clear visualization data. The AI/ML engine 104 is trained to classify the out-of-focus regions as background 208, such that those regions are ignored during further analysis. With explicit labeling as described herein, the pixels in the ambiguous regions (i.e., the pixels with moderate focus in between the fully in-focus regions and the fully out-of-focus regions) can be largely ignored by a human labeler. Instead, the labeler simply labels the clearly in-focus region with a foreground boundary 240 and labels the clearly out-of-focus regions with the background boundary 238 as shown in FIG. 11B. This permits the AI/ML engine 104 to decide where the boundary between background 208 and foreground 210 should be without the user explicitly labeling the boundary. This can be important when the exact boundary is ambiguous and/or does not matter, but it remains important to correctly classify the clear and in-focus regions.

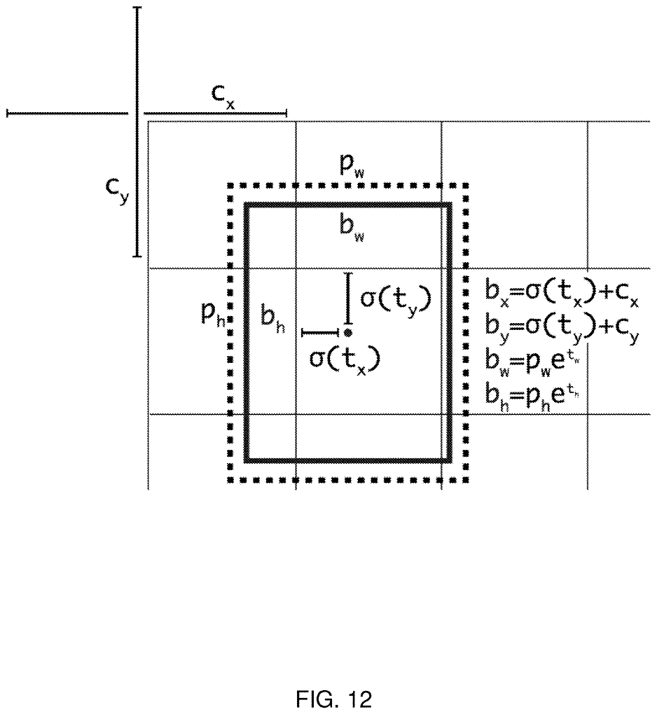

FIG. 12 illustrates a schematic diagram of a process for altering and optimizing the dimensions and shape of an anchor box around an object or particle within an image to generate a proposal box. The neural network first places an anchor box around an object, and then the neural network learns and implements offsets to optimize the dimensions of the anchor box around the object, as shown in FIG. 12.

Each grid unit within the input image 202 is fed into a neural network (may specifically be a Convolutional Neural Network). The neural network processes each grid unit and proposes an x-coordinate, y-coordinate, width, height, and indication of whether the grid unit likely includes an object. The neural network may propose this information in the following format: [x, y, w, h, o].

In an example implementation, the neural network is trained to identify and classify a specific bacterium, and is further trained to disregard all other cells, viruses, bacteria, mold spores, fibers, and so forth. In this implementation, the neural network may determine that a certain grid unit includes a cell but does not include the specific bacteria that the neural network is searching for. In this case, the neural network would classify that certain grid unit as not including an object, because that grid unit does not include the specific bacteria that is being identified and classified.

When the neural network determines that a certain grid unit does not include an object of interest, then that grid unit may be explicitly labeled as “background.” The explicit background grid units may be used to train the neural network and may be processed by the neural network.

The neural network learns offsets for every object classification. The anchor box illustrated in FIG. 12 is adjusted by the neural network according to a plurality of offsets. The shape and dimensions of each side of the rectangle may be adjusted based on the learned offsets. The neural network learns box and offsets for every classification, and the neural network specializes the anchor box for each classification.

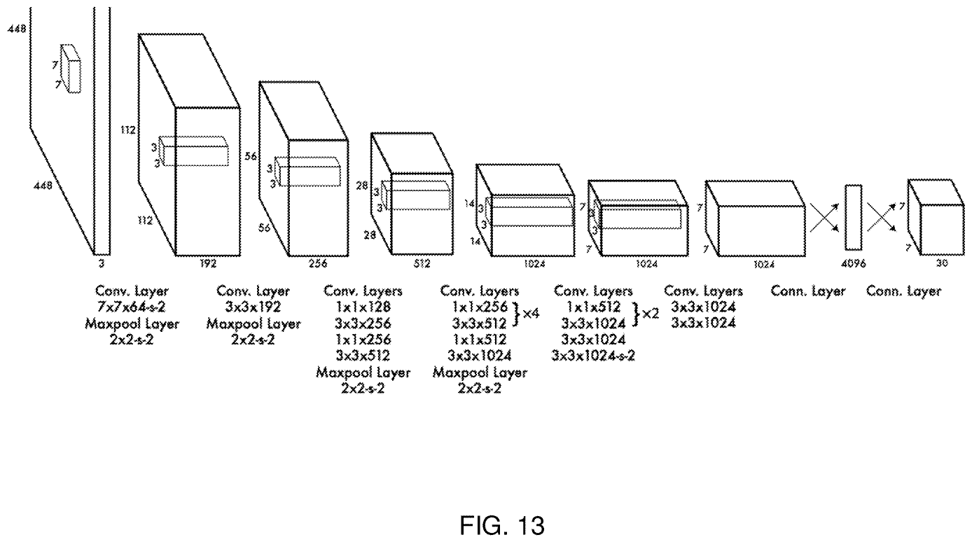

FIG. 13 is a schematic diagram of a convolutional neural network. The systems, methods, and processes for image classification that are described herein may be performed with a convolutional neural network such as the one illustrated in FIG. 13.

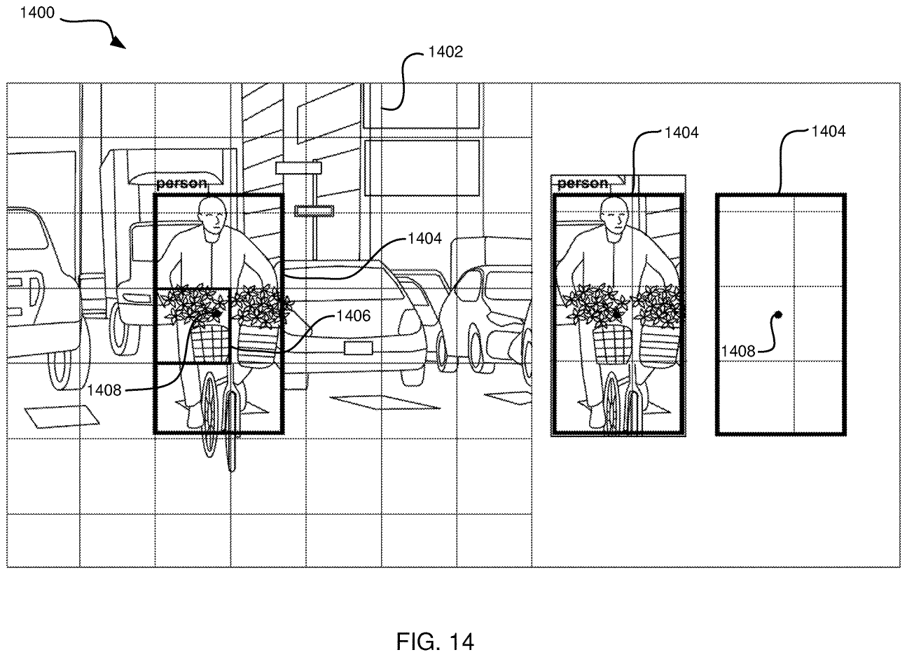

FIGS. 14-16 illustrate a labeling protocol and process flow for preparing a training dataset for a neural network or implementing the AI/ML engine 104 described herein with a trained neural network. Each of FIGS. 14-16 depict the same image of a street scene including a person riding a bicycle, multiple vehicles driving on a road, multiple buildings to the side of the road, and a street sign.

In the example implementation of the labeling protocol that is depicted in FIGS. 14-16, the neural network is trained to identify persons and street signs with a foreground classification. The neural network is further trained to implicitly indicate that other objects, such as vehicles, buildings, trees, road surface, and so forth have a background classification. The input image is partitioned into a plurality of grid units using vertical and horizontal grid lines 1402. Each of the plurality of grid units comprises an equivalent size, and each of the plurality of grid units is fed through the trained neural network to identify which of the grid units comprises an object of interest.

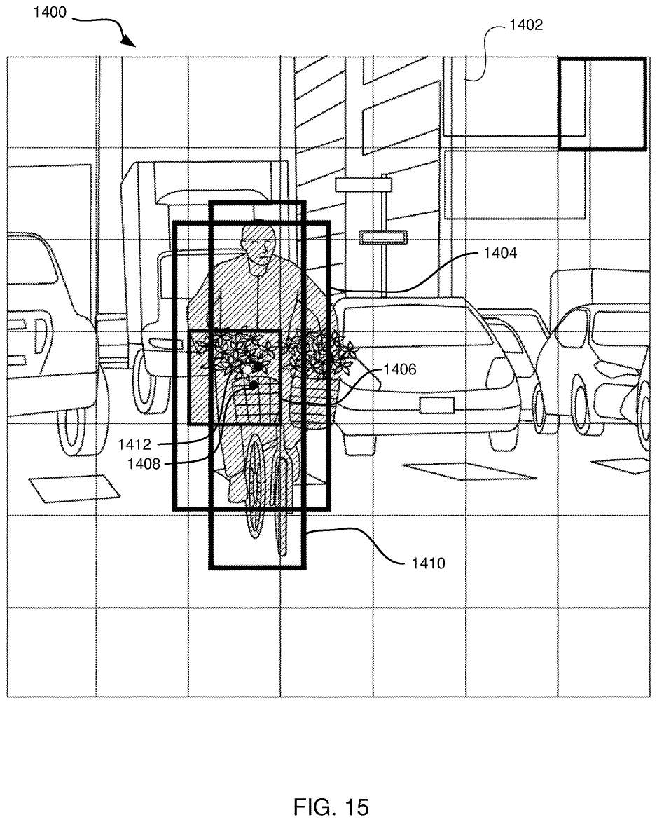

According to the labeling protocol, a boundary 1404 is drawn around a person, which has a foreground classification. The center point 1408 of the person is identified, and then then grid unit 1406 comprising the center point of the person is identified and highlighted. An additional boundary 1410 may be drawn around the person, which will have its own center point 1412. As shown in FIG. 15, the grid unit 1406 comprising the center point 1408, 1412 of the person is the same grid unit 1406 regardless of which boundary 1404, 1410 is used.

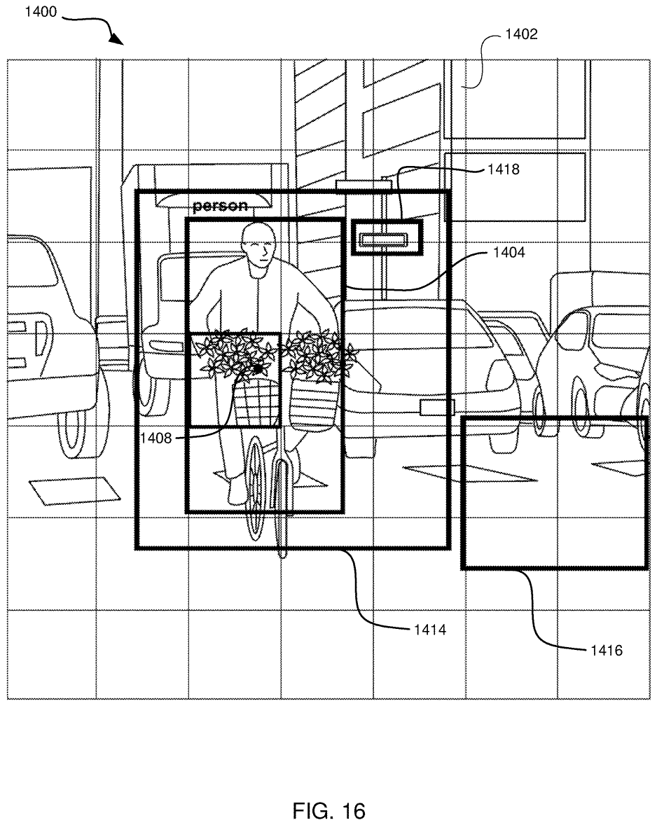

Further according to the labeling protocol, certain boundaries are drawn around background, and these boundaries are given the explicit background classification. FIG. 16 illustrates a first background boundary 1414 and a second background boundary 1416. The portions of the first background boundary 1414 that overlap the person boundary 1404 will be treated with the foreground classification, because the neural network is trained to override a background classification with a foreground classification.

Further according to the labeling protocol, an explicit boundary is drawn around a street sign to generate a street sign boundary 1418. The neural network is trained to treat the street sign boundary 1418 with a foreground classification even though it overlaps the first background boundary 1414.

According to the labeling protocol, the neural network is trained to ignore unlabeled parts of the image. The neural network learns background only learned from areas that are explicitly labeled with the background classification. This provides better granularity to the labeler as to what is and is not taught to the AI/ML engine 104.

The neural network independently assesses each grid unit within the image to determine whether that grid unit likely includes the object of interest (i.e., a person or street sign). The neural network draws an anchor box around the object of interest and then identifies a center point of the object of interest. The neural network further selects the grid unit that includes the center point of the object of interest.

When the neural network is to be trained to identify street signs in addition to persons (see FIG. 16), the training dataset only needs to be updated to also label every street sign within the existing boundaries in the training dataset. As shown in FIGS. 15-16, the background is explicitly labeled with the first and second background boundaries 1414, 1416, which each explicitly comprise the background classification. In this case, the neural network is only learning from those portions of the image that are explicitly labeled, including the explicitly labeled background and the explicitly labeled objects of interest (i.e., the person and the street sign).

According to the labeling protocol, boundaries within the training dataset that comprise the foreground classification will encourage the neural network to make an object of interest prediction within those boundaries. Additionally, training boundaries comprising the background classification inhibit the neural network from making an object of interest prediction within those boundaries. Further, training boundaries comprising each of the foreground classification and the background classification (see, e.g., overlap with 1404 and 1414 or overlap with 1418 and 1414) will encourage the neural network to make an object of interest prediction where the foreground classification overlaps the background classification.

According to the labeling protocol described herein, the training dataset may further include boundaries with the exclude boundary 246. Boundaries with the exclude boundary 246 will override all other classifications, including the foreground boundary 240 and the background boundary 238. During training of the AI/ML engine 104, if a boundary comprising the exclude classification comprises a center point of a boundary comprising the foreground classification, then a loss function will disregard all loss from the boundary comprising the foreground classification. Further, during training of the AI/ML engine 104, if a region of a boundary comprising the background classification overlaps a boundary comprising the exclude classification, then the loss function will disregard loss from the overlapping region.

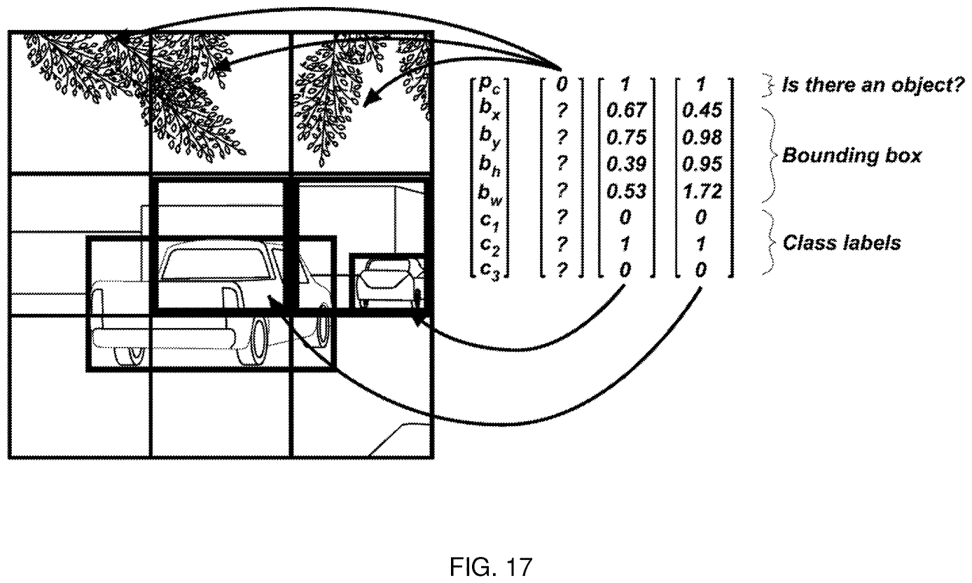

FIG. 17 illustrates an example implementation of the AI/ML engine 104 described herein.

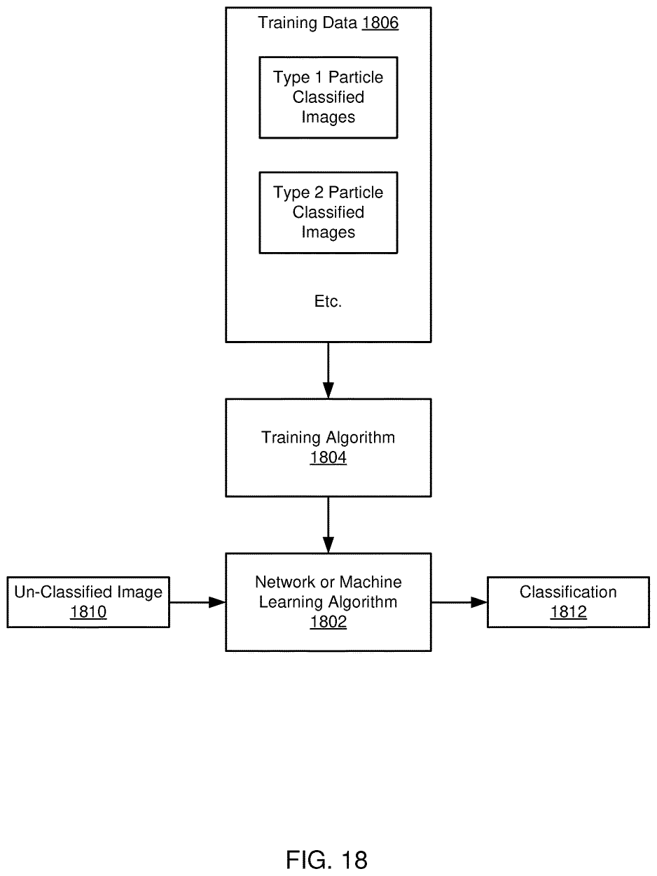

FIG. 18 is a schematic block diagram illustrating operation of a classification system according to one embodiment. In one embodiment, a network or machine learning algorithm 1802 (which may also be referred to as a hypothesis), may be trained and used for identifying and classifying or detecting particles in an image. The network or machine learning algorithm 1802 may include an AI/ML engine 104, such as a deep convolution neural network, or other machine learning model or algorithm for classifying or identifying particle types.

In one embodiment, the network or machine learning algorithm 1802 is trained using a training algorithm 1804 based on training data 1806. The training data 1806 may include images of particles or materials and their designated classifications. For example, the training data may include images classified as including particles or materials of a first type and images classified as including particles or materials of a second type. The types of the particles or materials may vary significantly based on the type of examination or report that is needed. Training data for any other type of particle, material type, or the like may be used. For example, training data for any particles that are to be identified by the machine learning algorithm 1802 may be provided. Using the training data, the training algorithm 1804 may train the machine learning algorithm 1802. For example, the training algorithm 1804 may use any type or combination of supervised or unsupervised machine learning algorithms.

Once the network or machine learning algorithm 1802 is trained, the network or machine learning algorithm 1802 may be used to identify or predict the type of particle within an image. For example, an unclassified image 1810 (or previously classified image with the classification information removed) is provided to the network or machine learning algorithm 1802 and the network or machine learning algorithm 1802 outputs a classification 1812. The classification 1812 may indicate a yes or no for the presence of a specific type of particle. For example, the network or machine learning algorithm 1802 may be targeted to detecting whether a specific type of mold, bacteria, particle, or material is present in the un-classified image 1810. Alternatively, the classification 1812 may indicate one of many types that may be detected by the network or machine learning algorithm 1802. For example, the network or machine learning algorithm 1802 may provide a classification that indicates which type of particle is present in the un-classified image 1810. During training, the classification 1812 may be compared to a human classification or an out-of-channel classification to determine how accurate the network or machine learning algorithm 1802 is. If the classification 1812 is incorrect, the un-classified image 1810 may be assigned a classification from a human and used as training data 1806 to further improve the network or machine learning algorithm 1802.

In one embodiment, both offline and online training of the network or machine learning algorithm 1802 may be performed. For example, after an initial number of rounds of training, an initial accuracy level may be achieved. The network or machine learning algorithm 1802 may then be used to assist in classification with close review by human workers. As additional data comes in the data may be classified by the network or machine learning algorithm 1802, reviewed by a human, and then added to a body of training data for use in further refining training of the network or machine learning algorithm 1802. Thus, the more the network or machine learning algorithm 1802 is used, the better accuracy it may achieve. As the accuracy is improved, less and less oversight of human workers may be needed.

As discussed previously, machine learning algorithms or neural networks must generally be trained before using them. However, training data can be difficult to obtain. Regarding mold spores, for example, images of specific types of mold spores may be rare. Similarly, it may sometimes be necessary to distinguish between two similar mold spores (or visually identical at least to a human). Such training may be difficult to do well without samples containing both types of mold spores since other differences in the slide, background material, included material, or the like in a sample may differ between samples. If the two different classifications of mold spores are not located in the same imaged sample, then the training algorithms may inaccurately distinguish between particles based on these other details which may lower classification accuracy.

To improve distinction between visually similar or hard to find particles, synthetic images may be generated for training. For example, particles or mold spores may be segmented from different source images and placed on a shared background to create a synthetic microscopy image. Particles or mold spores may be segmented from the source images using automatic segmentation algorithms, such as intelligent scissors, magic scissors, watershed, grabcut, TVSeg, segmentation, or boundary finding algorithms. For example, a source image (e.g., an image of a cultured population or sample of mold spores) may be processed to locate spores or particles within the source image and/or create anchor boxes around the spores or particles. Once those locations are determined, an automatic segmentation algorithm may be used to “cut out” the pixels corresponding to the particle within the anchor boxes and then “paste” them onto a background to create the synthetic image.

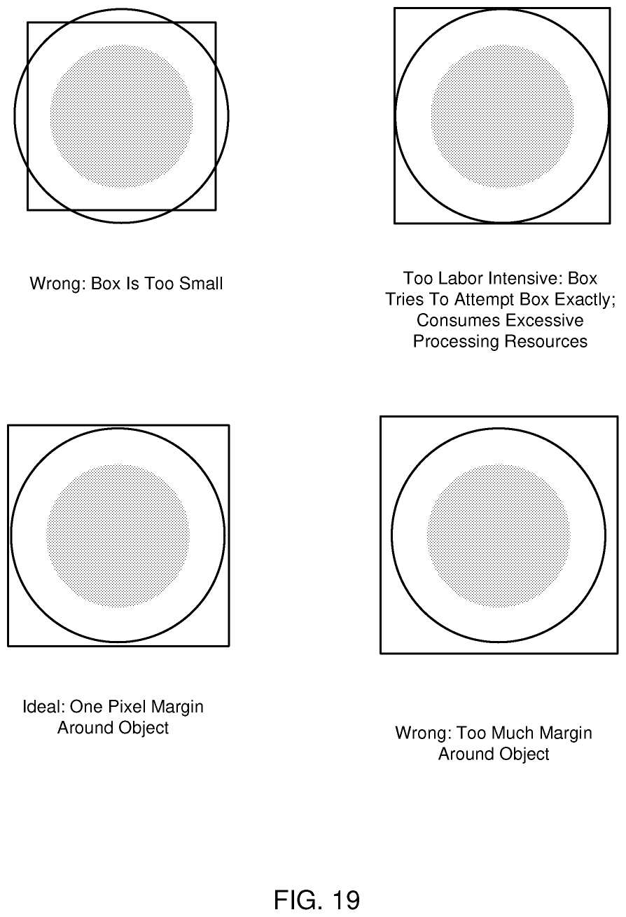

FIG. 19 illustrates instructions for labelers (human labelers or the image processing algorithm) to draw boxes around foreground objects. A one-pixel margin allows the labeler to quickly draw a consistent box because they can see the 1-pixel margin between the object and the box. An inconsistent margin around foreground objects creates noisy loss because the loss function penalizes any variation between the proposal and the label. This penalty is just noise that does not improve model performance and can make debugging more complicated.

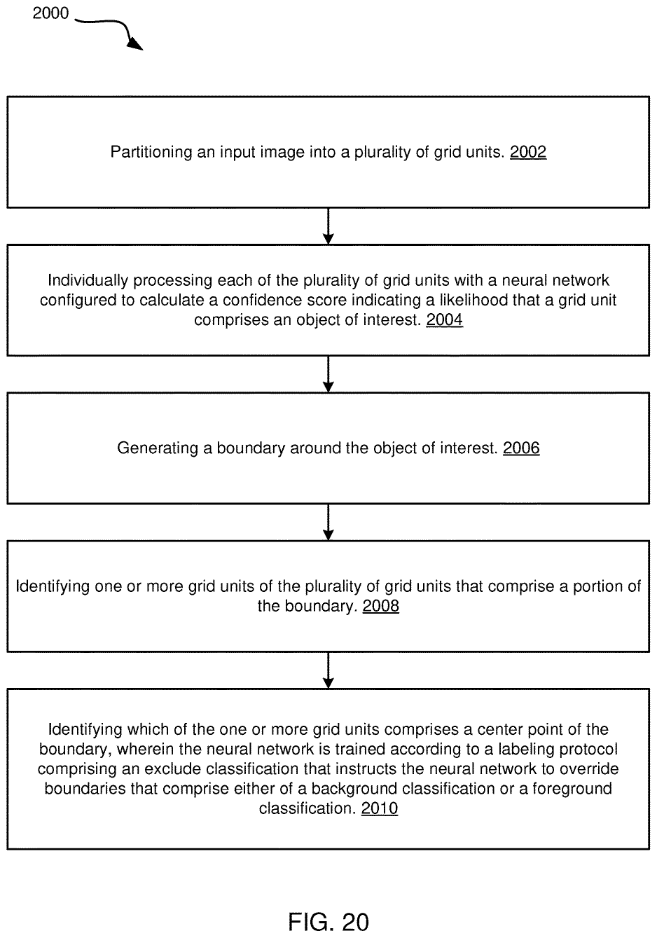

FIG. 20 is a schematic flow chart diagram of a method 2000 for automated image analysis (see 120) for partitioning pixel data into foreground classifications and background classifications. The method 2000 may be executed on a grid-by-grid basis as described herein. Notably, a grid may include a one-by-one grid such that the grid is a single pixel. Thus, the method 2000 may be performed on larger grids and may likewise be performed on a pixelwise basis.

The method 2000 includes partitioning at 2002 an input image (see 202) into a plurality of grid units, wherein the grid units may include one-by-one grids comprising a single pixel, and alternatively or additionally the grid units may include larger grid units comprising numerous pixels. The method 2000 includes individually processing at 2004 each of the plurality of grid units with a neural network (see AI/ML engine 104) to calculate a confidence score indicating a likelihood that a grid unit comprises an object of interest. The method 2000 includes generating at 2006 a boundary around the object of interest. The method includes identifying at 2008 one or more grid units of the plurality of grid units that comprises a portion of the boundary. The method includes identifying at 2010 which of the one or more grid units comprises a center point of the boundary, wherein the neural network is trained according to a labeling protocol comprising an exclude classification that instructs the neural network (see AI/ML engine 104) to override boundaries that comprise either of a background classification or a foreground classification.

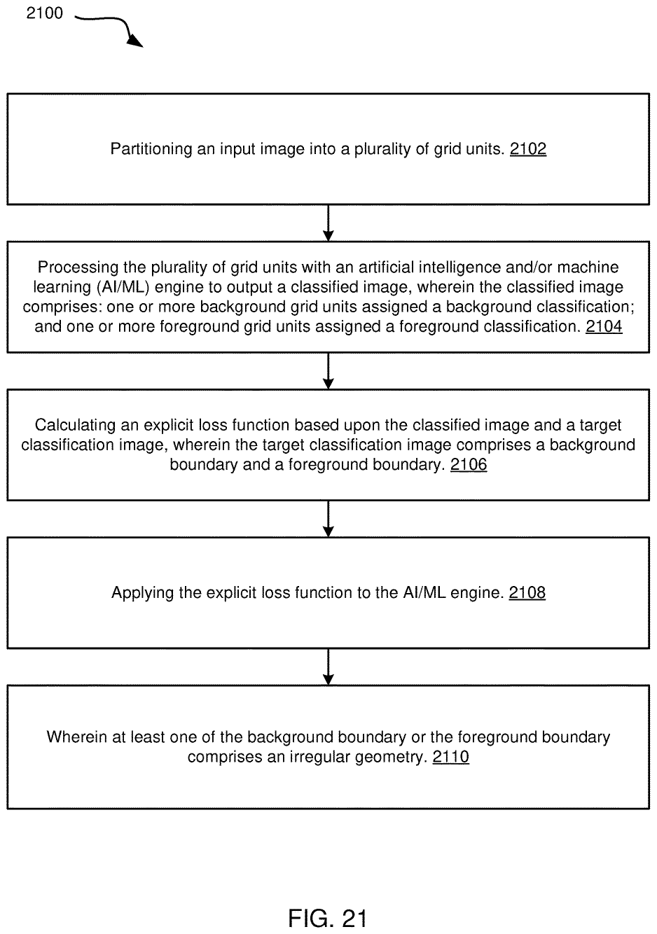

FIG. 21 is a schematic flow chart diagram of a method 2100 for automated image analysis (see 120) for partitioning pixel data into foreground classifications and background classifications. The method 2000 may be executed on a grid-by-grid basis as described herein. Notably, a grid may include a one-by-one grid such that the grid is a single pixel. Thus, the method 2000 may be performed on larger grids and may likewise be performed on a pixelwise basis.

The method 2100 includes partitioning at 2102 an input image (see 202) into a plurality of grid units, wherein the grid units may include one-by-one grids comprising a single pixel, and alternatively or additionally the grid units may include larger grid units comprising numerous pixels. The method 2100 includes processing at 2104 the plurality of grid units with the AI/ML engine (see 104) to output a classified image (see automated image analysis 120 result). The classified image includes one or more background grid units assigned a background (see 208) classification. The classified image includes one or more foreground grid units assigned a foreground (see 210) classification. The method 2100 includes calculating at 2106 an explicit loss function (see 232) based upon the classified image and a target classification (see 230) image, wherein the target classification image comprises a background boundary (see 238) and a foreground boundary (see 240). The method 2100 includes applying at 2108 the explicit loss function to the AI/ML engine.

The method 2100 is such that at least one of the background boundary or the foreground boundary comprises an irregular geometry. As described herein, an “irregular geometry” includes: any shape or spatial configuration that lacks uniform symmetry, periodicity, or conformity to standard geometric primitives; and any shape or spatial configuration wherein the boundaries cannot be fully described by a single closed-form mathematical expression or simple parametric equation.

such that at least one of the background boundary or the foreground boundary comprises a shape, region, or structure that has no consistent, regular, or symmetrical pattern. The irregular geometry may include a polygon with sides and angles of unequal length or measure, such as a scalene triangle or a freehand polygon. The irregular geometry may include a shape with non-uniform cross-sections.

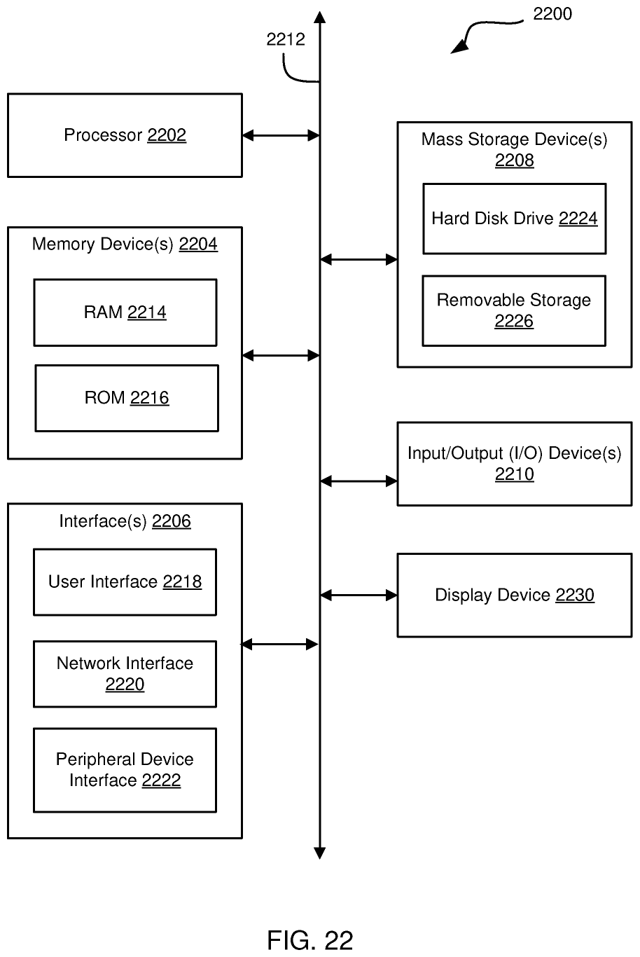

Referring now to FIG. 22, a block diagram of an example computing device 2200 is illustrated. Computing device 2200 may be used to perform various procedures, such as those discussed herein. Computing device 2200 can perform various monitoring functions as discussed herein, and can execute one or more application programs, such as the application programs or functionality described herein. Computing device 2200 can be any of a wide variety of computing devices, such as a desktop computer, in-dash computer, vehicle control system, a notebook computer, a server computer, a handheld computer, tablet computer and the like.

Computing device 2200 includes one or more processor(s) 2202, one or more memory device(s) 2204, one or more interface(s) 2206, one or more mass storage device(s) 2208, one or more Input/output (I/O) device(s) 2210, and a display device 2230 all of which are coupled to a bus 2212. Processor(s) 2202 include one or more processors or controllers that execute instructions stored in memory device(s) 2204 and/or mass storage device(s) 2208. Processor(s) 2202 may also include diverse types of computer-readable media, such as cache memory.

Memory device(s) 2204 include various computer-readable media, such as volatile memory (e.g., random access memory (RAM) 2214) and/or nonvolatile memory (e.g., read-only memory (ROM) 2216). Memory device(s) 2204 may also include rewritable ROM, such as Flash memory.

Mass storage device(s) 2208 include various computer readable media, such as magnetic tapes, magnetic disks, optical disks, solid-state memory (e.g., Flash memory), and so forth. As shown in FIG. 22, a particular mass storage device 2208 is a hard disk drive 2224. Various drives may also be included in mass storage device(s) 2208 to enable reading from and/or writing to the various computer readable media. Mass storage device(s) 2208 include removable media 2226 and/or non-removable media.

I/O device(s) 2210 include various devices that allow data and/or other information to be input to or retrieved from computing device 2200. Example I/O device(s) 2210 include cursor control devices, keyboards, keypads, microphones, monitors or other display devices, speakers, printers, network interface cards, modems, barcode scanners, and the like.

Display device 2230 includes any type of device capable of displaying information to one or more users of computing device 2200. Examples of display device 2230 include a monitor, display terminal, video projection device, and the like.

Interface(s) 2206 include various interfaces that allow computing device 2200 to interact with other systems, devices, or computing environments. Example interface(s) 2206 may include any number of different network interfaces 2220, such as interfaces to local area networks (LANs), wide area networks (WANs), wireless networks, and the Internet. Other interface(s) include user interface 2218 and peripheral device interface 2222. The interface(s) 2206 may also include one or more user interface elements 2218. The interface(s) 2206 may also include one or more peripheral interfaces 2222 such as interfaces for printers, pointing devices (mice, track pad, or any suitable user interface now known to those of ordinary skill in the field, or later discovered), keyboards, and the like.

Bus 2212 allows processor(s) 2202, memory device(s) 2204, interface(s) 2206, mass storage device(s) 2208, and I/O device(s) 2210 to communicate with one another, as well as other devices or components coupled to bus 2212. Bus 2212 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 900 and are executed by processor(s) 902. Alternatively, the systems and procedures described herein can be implemented in hardware, or a combination of hardware, software, and/or firmware. For example, one or more application specific integrated circuits (ASICs) can be programmed to conduct one or more of the systems and procedures described herein.

### EXAMPLES

The following examples pertain to further embodiments of the disclosure.

Example 1 is a method. The method includes receiving an input image. The method includes partitioning the input image into a plurality of grid units. The method includes providing each of the plurality of grid units to a neural network trained to identify an object of interest within the input image, wherein the neural network is trained to calculate a confidence score for each of the plurality of grid units indicating a likelihood that a grid unit comprises the object of interest.

Example 2 is a method as in Example 1, wherein the neural network independently assesses each of the plurality of grid units.

Example 3 is a method as in any combination of any of Examples 1-2, wherein the neural network calculates the confidence score for a first grid unit based on image data within the grid unit and further based on image data within the input image that is not present within the grid unit.

Example 4 is a method as in any combination of any of Examples 1-3, wherein the neural network is a convolutional neural network.

Example 5 is a method as in any combination of any of Examples 1-4, wherein each of the plurality of grid units comprises equivalent dimensions.

Example 6 is a method as in any combination of any of Examples 1-5, further comprising receiving the confidence score from the neural network, wherein a confidence score of zero indicates that the grid unit is unlikely to comprise the object of interest.

Example 7 is a method as in any combination of any of Examples 1-6, further comprising receiving the confidence score from the neural network for the grid unit, wherein a confidence score of one indicates that the grid unit is likely to comprise the object of interest.

Example 8 is a method as in any combination of any of Examples 1-7, further comprising, in response to receiving an indication that the grid unit is unlikely to comprise the object of interest, classifying the image data within the grid unit as explicit background.

Example 9 is a method. The method includes partitioning an input image into a plurality of grid units. The method includes individually processing each of the plurality of grid units with a neural network configured to calculate a confidence score indicating a likelihood that a grid unit comprises an object of interest. The method includes generating a boundary around the object of interest. The method includes identifying one or more grid units of the plurality of grid units that comprise a portion of the boundary. The method includes identifying which of the one or more grid units comprises a center point of the boundary.

Example 10 is a method as in Example 9, further comprising executing a loss function to ignore all grid units of the plurality of grid units that are assigned a confidence score indicating a low likelihood of comprising an object of interest.

Example 11 is a method as in any combination of any of Examples 1-10, further comprising providing image data within the boundary to a neural network trained to classify an identity of the object of interest within the boundary.

Example 12 is a method as in any combination of any of Examples 1-11, further comprising calculating x-axis coordinates, y-axis coordinates, width, and height of each of the plurality of grid units.

Example 13 is a method as in any combination of any of Examples 1-12, further comprising calculating, for each of the one or more grid units, a percentage of the boundary that is located within each of the one or more grid units.

Example 14 is a method as in any combination of any of Examples 1-13, further comprising training the neural network on a training dataset comprising a plurality of training images, wherein the plurality of training images comprise boundary classifications selected from a list comprising: foreground, anti-class, background, exclude, merge, and ignore.

Example 15 is a method as in any combination of any of Examples 1-14, wherein the training dataset identifies training boundaries as comprising the foreground classification if a user determines those training boundaries comprise an object of interest that is selected to be detected and classified by the neural network.

Example 16 is a method as in any combination of any of Examples 1-15, wherein training boundaries comprising the anti-class classification instruct the neural network to separate training boundaries comprising the foreground classification from training boundaries comprising background classification; and wherein the neural network is instructed to treat training boundaries comprising the anti-class classification as a foreground object for classification and as a background object for reporting.

Example 17 is a method as in any combination of any of Examples 1-16, wherein training boundaries comprising the foreground classification encourage the neural network to make an object of interest prediction within those training boundaries; and wherein training boundaries comprising the background classification inhibit the neural network from making an object of interest prediction within those training boundaries.

Example 18 is a method as in any combination of any of Examples 1-17, wherein the neural network is instructed that training boundaries comprising the exclude classification will override training boundaries comprising either of the background classification or the foreground classification such that: during training of the neural network, if a boundary comprising the exclude classification contains the center of a boundary comprising the foreground classification, then the neural network will disregard the boundary comprising the foreground classification; and during training of the neural network, if a region of a boundary comprising the background classification overlaps a boundary comprising the exclude classification, then the neural network will disregard the overlapping portion of the background classification boundary.

Example 19 is a method as in any combination of any of Examples 1-18, wherein the merge classification indicates that two or more types of objects of interest are merged into a single class.

Example 20 is a method as in any combination of any of Examples 1-19, wherein the ignore classification indicates that a training object of interest within a boundary comprising the ignore classification should be treated by the neural network as if the training object of interest does not exist.

Example 21 is a method as in any combination of any of Examples 1-20, wherein the plurality of grid units each comprise equivalent dimensions.

Example 22 is a method as in any combination of any of Examples 1-21, wherein generating the boundary around the object of interest comprises selecting dimensions for the boundary based on dimensions of the object of interest; and wherein the method further comprises determining an identity of the object of interest based only on pixel data within the boundary.

Example 23 is a method as in any combination of any of Examples 1-22, wherein the input image depicts one or more of cells, viruses, bacteria, mold spores, or fibers.

Example 24 is a method as in any combination of any of Examples 1-23, wherein the input image is captured by an image sensor associated with a microscope, and wherein the input image comprises a microscope slide image.

Example 25 is a method as in any combination of any of Examples 1-24, further comprising training the neural network with a plurality of synthetic images; wherein the plurality of synthetic images comprises pixel values depicting particles segmented from sources images and placed on a synthetic background to generate a synthetic microscopy slide image.

Example 26 is a method as in any combination of any of Examples 1-25, wherein the particles depicted in the plurality of synthetic images comprises one or more of cells, viruses, bacteria, mold spores, or fibers.

Example 27 is a method as in any combination of any of Examples 1-26, further comprising generating a synthetic image for training the neural network using an automated segmentation algorithm configured to: receive a non-synthetic microscopy slide image comprising an object boundary around a plurality of object pixels; crop out the plurality of object pixels within the object boundary; and paste the plurality of object pixels on to a synthetic background.

Example 28 is a method as in any combination of any of Examples 1-27, further comprising: during training of the neural network, evaluating whether the confidence score indicating the likelihood that the grid unit comprises the object of interest is correct; and in response to the neural network outputting an incorrect confidence score, penalizing the neural network using a loss function.

Example 29 is a method as in any combination of any of Examples 1-27. The method includes partitioning an input image into a plurality of grid units. The method includes processing the plurality of grid units with an artificial intelligence and/or machine learning (AI/ML) engine to output a classified image, wherein the classified image comprises: one or more background grid units assigned a background classification; and one or more foreground grid units assigned a foreground classification. The method includes calculating an explicit loss function based upon the classified image and a target classification image, wherein the target classification image comprises a background boundary and a foreground boundary. The method includes applying the explicit loss function to the AI/ML engine. The method is such that wherein at least one of the background boundary or the foreground boundary comprises an irregular geometry.

Example 30 is a method as in any combination of any of Examples 1-29, wherein the foreground boundary is imprecise, such that the foreground boundary encompasses fewer than all pixels associated with an object of interest depicted in the input image.

Example 31 is a method as in any combination of any of Examples 1-30, wherein the background boundary overlaps the foreground boundary to form an overlapping region; and wherein a foreground classification overrides a background classification such that the overlapping region is classified as comprising foreground pixel data.

Example 32 is a method as in any combination of any of Examples 1-31, wherein the AI/ML engine is trained to assess the overlapping region to identify a pixelwise boundary between the foreground pixel data and background pixel data within the overlapping region.

Example 33 is a method as in any combination of any of Examples 1-32, wherein the explicit loss function trains the AI/ML engine to learn a pixelwise boundary between the foreground pixel data and background pixel data in response to identifying that the background boundary overlaps the foreground boundary.

Example 34 is a method as in any combination of any of Examples 1-33, wherein the target classification comprises unclassified regions, and wherein the unclassified regions comprise unclassified pixel data that is neither background nor foreground for purposes of calculating the explicit loss function.

Example 35 is a method as in any combination of any of Examples 1-34, wherein the classified image further comprises one or more unclassified grid units assigned an unclassified classification.

Example 36 is a method as in any combination of any of Examples 1-35, wherein at least a portion of the plurality of grid units is a one-by-one grid unit comprising a single pixel.

Example 37 is a method as in any combination of any of Examples 1-36, wherein at least a portion of the plurality of grid units is an “x”-by-“y” grid unit, and wherein at least one of “x” or “y” is greater than one.

Example 38 is a method as in any combination of any of Examples 1-37, wherein pixel data within the foreground boundary depicts an object of interest.

Example 39 is a method as in any combination of any of Examples 1-38, wherein the plurality of grid units are one-by-one grid units comprising a single pixel, such that processing the plurality of grid units with the AI/ML engine comprises pixelwise processing of the input image; wherein the one or more background grid units assigned the background classification comprises a plurality of individual background pixels each assigned the background classification; and wherein the one or more foreground grid units assigned the foreground classification comprises a plurality of individual foreground pixels each assigned the background classification.

Example 40 is a method as in any combination of any of Examples 1-39, wherein the explicit loss function causes the AI/ML engine to make an object of interest prediction on pixel data encompassed by the foreground boundary.

Example 41 is a method as in any combination of any of Examples 1-40, wherein the explicit loss function inhibits the AI/ML engine from making an object of interest prediction on pixel data encompassed by the background boundary.

Example 42 is a method as in any combination of any of Examples 1-41, wherein the explicit loss function causes the AI/ML engine to make an object of interest prediction on overlapping pixel data, wherein the overlapping pixel data is located in an overlapping region wherein the background boundary overlaps the foreground boundary.

Example 43 is a method as in any combination of any of Examples 1-42, wherein the target classification image further comprises an exclude boundary that overlaps one or more of the background boundary or the foreground boundary to create an overlapping boundary; wherein an exclude classification overrides each of the background classification and the foreground classification, such that the explicit loss function trains the AI/ML to disregard pixels within the overlapping boundary.

Example 44 is a method as in any combination of any of Examples 1-43, wherein the target classification image further comprises unclassified pixels that are not located within any boundary type, and wherein the explicit loss function trains the AI/ML engine to ignore the unclassified pixels.

Example 45 is a method as in any combination of any of Examples 1-44, wherein the plurality of grid units each comprise equivalent dimensions.

Example 46 is a method as in any combination of any of Examples 1-45, wherein the input image is captured by an image sensor associated with a microscope, and wherein the input image depicts a microscope slide comprising one or more of cells, viruses, bacteria, mold spores, or fibers.

Example 47 is a method as in any combination of any of Examples 1-46, further comprising training the neural network with a plurality of synthetic images, and wherein the plurality of synthetic images comprises pixel values depicting particles segmented from source images and placed on a synthetic background to generate a synthetic microscopy slide image.

Example 48 is a method as in any combination of any of Examples 1-47, further comprising generating a synthetic image for training the neural network using an automated segmentation algorithm configured to: receive a non-synthetic microscopy slide image comprising an object boundary around a plurality of object pixels; crop out the plurality of object pixels within the object boundary; and paste the plurality of object pixels on to a synthetic background.

Example 49 is a system comprising one or more processors configured to execute instructions stored in non-transitory computer readable storage medium. The instructions comprise any of the method steps of any combination of any of Examples 1-48.

Example 30 is non-transitory computer readable storage medium storing instructions for execution by one or more processors. The instructions comprise any of the method steps of any combination of any of Examples 1-48.

The embodiments of systems, methods, and devices discussed herein may be applied to a wide range of sample types for detection of various particles, materials, or the like. The following paragraphs describe diverse types of samples which may be imaged and identified using methods, systems, or devices disclosed herein.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

Many of the functional units described in this specification may be implemented as one or more components, which is a term used to emphasize their implementation independence more particularly. For example, a component may be implemented as a hardware circuit comprising custom very large-scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, and the like.

Components may also be implemented in software for execution by diverse types of processors. An identified component of executable code may, for instance, include one or more physical or logical blocks of computer instructions, which may, for instance, be organized as an object, a procedure, or a function. Nevertheless, the executables of an identified component need not be physically located together but may include disparate instructions stored in separate locations that, when joined logically together, include the component, and achieve the stated purpose for the component.

Indeed, a component of executable code may be a single instruction, or many instructions, and may even be distributed over several different code segments, among different programs, and across several memory devices. Similarly, operational data may be identified and illustrated herein within components and may be embodied in any suitable form and organized within any suitable type of data structure. The operational data may be collected as a single data set or may be distributed over separate locations including over different storage devices, and may exist, at least partially, merely as electronic signals on a system or network. The components may be passive or active, including agents operable to perform desired functions.

Implementations of the disclosure can also be used in cloud computing environments. In this application, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, or any suitable characteristic now known to those of ordinary skill in the field, or later discovered), service models (e.g., Software as a Service (Saas), Platform as a Service (PaaS), Infrastructure as a Service (IaaS)), and deployment models (e.g., private cloud, community cloud, public cloud, hybrid cloud, or any suitable service type model now known to those of ordinary skill in the field, or later discovered). Databases and servers described with respect to the disclosure can be included in a cloud model.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the present disclosure should, therefore, be determined only by the claims, if any.

When labeling images, it is possible for the labeler to want to have an area be labeled as background, except for a small area around it. This creates a “donut” like shape where there are one or more “holes” in the background label. These “holes” are created by drawing an “exclude” label over the background label. Where exclude labels exist, it is functionally equivalent to not having another label there. Exclude labels 246 allow for even more detailed labeling of images.

What is claimed is:

1. A method comprising:
partitioning an input image into a plurality of grid units;
processing the plurality of grid units with an artificial intelligence and/or machine learning (AI/ML) engine to output a classified image, wherein the classified image comprises:
one or more background grid units assigned a background classification; and
one or more foreground grid units assigned a foreground classification;
calculating an explicit loss function based upon the classified image and a target classification image, wherein the target classification image comprises a background boundary and a foreground boundary; and
applying the explicit loss function to the AI/ML engine;
wherein at least one of the background boundary or the foreground boundary comprises an irregular geometry.

2. The method of claim 1, wherein the foreground boundary is imprecise, such that the foreground boundary encompasses fewer than all pixels associated with an object of interest depicted in the input image.

3. The method of claim 1, wherein the background boundary overlaps the foreground boundary to form an overlapping region; and
wherein a foreground classification overrides a background classification such that the overlapping region is classified as comprising foreground pixel data.

4. The method of claim 3, wherein the AI/ML engine is trained to assess the overlapping region to identify a pixelwise boundary between the foreground pixel data and background pixel data within the overlapping region.

5. The method of claim 3, wherein the explicit loss function trains the AI/ML engine to learn a pixelwise boundary between the foreground pixel data and background pixel data in response to identifying that the background boundary overlaps the foreground boundary.

6. The method of claim 1, wherein the target classification comprises unclassified regions, and wherein the unclassified regions comprise unclassified pixel data that is neither background nor foreground for purposes of calculating the explicit loss function.

7. The method of claim 6, wherein the classified image further comprises one or more unclassified grid units assigned an unclassified classification.

8. The method of claim 1, wherein at least a portion of the plurality of grid units is a one-by-one grid unit comprising a single pixel.

9. The method of claim 1, wherein at least a portion of the plurality of grid units is an “x”-by-“y” grid unit, and wherein at least one of “x” or “y” is greater than one.

10. The method of claim 1, wherein pixel data within the foreground boundary depicts an object of interest.

11. The method of claim 1, wherein the plurality of grid units are one-by-one grid units comprising a single pixel, such that processing the plurality of grid units with the AI/ML engine comprises pixelwise processing of the input image;
wherein the one or more background grid units assigned the background classification comprises a plurality of individual background pixels each assigned the background classification; and
wherein the one or more foreground grid units assigned the foreground classification comprises a plurality of individual foreground pixels each assigned the background classification.

12. The method of claim 1, wherein the explicit loss function causes the AI/ML engine to make an object of interest prediction on pixel data encompassed by the foreground boundary.

13. The method of claim 1, wherein the explicit loss function inhibits the AI/ML engine from making an object of interest prediction on pixel data encompassed by the background boundary.

14. The method of claim 1, wherein the explicit loss function causes the AI/ML engine to make an object of interest prediction on overlapping pixel data, wherein the overlapping pixel data is located in an overlapping region wherein the background boundary overlaps the foreground boundary.

15. The method of claim 1, wherein the target classification image further comprises an exclude boundary that overlaps one or more of the background boundary or the foreground boundary to create an overlapping boundary;
wherein an exclude classification overrides each of the background classification and the foreground classification, such that the explicit loss function trains the AI/ML to disregard pixels within the overlapping boundary.

16. The method of claim 1, wherein the target classification image further comprises unclassified pixels that are not located within any boundary type, and wherein the explicit loss function trains the AI/ML engine to ignore the unclassified pixels.

17. The method of claim 1, wherein the plurality of grid units each comprise equivalent dimensions.

18. The method of claim 1, wherein the input image is captured by an image sensor associated with a microscope, and wherein the input image depicts a microscope slide comprising one or more of cells, viruses, bacteria, mold spores, or fibers.

19. The method of claim 1, further comprising training the neural network with a plurality of synthetic images, and wherein the plurality of synthetic images comprises pixel values depicting particles segmented from source images and placed on a synthetic background to generate a synthetic microscopy slide image.

20. The method of claim 1, further comprising generating a synthetic image for training the neural network using an automated segmentation algorithm configured to:
receive a non-synthetic microscopy slide image comprising an object boundary around a plurality of object pixels;
crop out the plurality of object pixels within the object boundary; and
paste the plurality of object pixels on to a synthetic background.
